(19) United States
(12) Patent Application Publication
(10) Pub. No.: US 2015/0082142 A1
(43) Pub. Date: Mar. 19, 2015

(54) METHOD FOR STORING AND APPLYING RELATED SETS OF PATTERN/MESSAGE RULES

(71) Applicant: Citadel Corporation PTY LTD, Adelaide (AU)

(72) Inventor: Ross Neil Williams, Adelaide (AU)

(21) Appl. No.: 14/396,730

(22) PCT Filed: Apr. 29, 2013
(86) PCT No.: PCT/AU2013/000440

§ 371 Date: Oct. 23, 2014

(30) Foreign Application Priority Data
Apr. 27, 2012 (AU) 2012901661

(51) Int. Cl. G06F 17/24

(52) U.S. Cl. CPC G06F 17/241
USPC 715/231

(57) ABSTRACT

This invention provides a method and apparatus for efficiently storing and applying related sets of pattern/message rules that are used to analyse and annotate blocks of text. Where sets of rules can include other sets, representations of the sets that speed analysis can contain significant redundancy and add to the consumption of memory. In a one aspect of the invention, all rules are represented in a single pattern-matching data structure (which is applied to a block of text to find all matches by all rules) and the rulesets are represented using boolean vectors (one of which is used to filter the matches) which are compressed by identifying common subspans. In a further aspect of the invention, each ruleset is represented by its own pattern-matching data structure, and these are compressed by identifying common parts. In each aspect, the effect is to allow the creation of a data structure that can speed up matching without consuming excessive memory.

### INCORPORATION BY REFERENCE

The following patent application and terminology used therein is referred to in the following description: PCT/AU2012/000393 titled “METHOD FOR IDENTIFYING POTENTIAL DEFECTS IN A BLOCK OF TEXT USING SOCIALLY CONTRIBUTED PATTERN/MESSAGE RULES” filed on 18 Apr. 2012 claiming priority from Australian Provisional Patent Application No. 2011901449 and the content of this co-owned application is incorporated by reference in its entirety.

### FIELD

The present invention provides a method and apparatus for efficiently storing and applying related sets of pattern/message rules for the purpose of analysing and annotating blocks of text.

### BACKGROUND

### Pattern/Message Rules and Rulesets

This invention is applicable in a context where sets of pattern/message rules are applied to blocks of text for the purpose of identifying defects in the blocks of text. Here are some examples of pattern/message rules. Each line is a rule, with the rule's pattern on the left, and the corresponding message on the right.
greatful->The correct spelling is “grateful”
marshall art->Did you mean “martial art”?
reductio ab absurdum->This should be “reductio ad absurdum”
statue of libertie-22 This should be “statue of liberty”
statue of limitations->This should be “statute of limitations”

This is reproduced in FIG. 1. Groups of rules will be referred to as “rulesets”.

To analyse a block of text using a set of rules, the block of text is searched for matches to the patterns, and wherever a pattern matches in the text, the corresponding message is attached to the text as an annotation. FIG. 2 shows an example of an annotation report resulting from the application of the rules in FIG. 1 to a block of text.

### A Simple Implementation

The simplest way to match a set of rules with a block of text is to run through the block of text once for each rule searching for matches to the rule's pattern. If there are R rules and the block of text is T characters long, then applying the R rules to the text will require approximately R×T matching operations (O(RT) matching operations in complexity notation, where each matching operation might require a few character comparisons (but each of which is effectively O(1) if matches are unusual)).

Performing R searches is practical for small sets of rules. However, for large sets of rules, the number of operations required will make the system too slow. For example, if the text is 10,000 characters long, and there are one million rules, then matching them using this simple method will require about ten billion operations. Modern CPUs can perform approximately two billion operations per second, so the matching operation would take at least five seconds of CPU time. This is impractical for (e.g.) a web server that must process many text analysis requests per second.

### Time Complexity Notation

This specification uses computer science time complexity notation to describe the time complexity of various operations. The time complexity of an operation is a characterisation of the rate at which the time taken to perform an operation increases with the size of the operation's inputs.

For example, if there were a set of rules V, and a block of text W, and the rules were applied to the block by performing one pass over T for each rule, then the time complexity of the operation would be O(VW). Within this specific example of notation, V is interpreted to mean the number of rules in V, and T is interpreted to mean the length of the block W, so in this example, the notation O(VW) indicates that the time taken to perform the operation will increase in a manner proportional to the product of the number of rules and the length of the block of text.

More information on time complexity can be found in Wikipedia at:

http://en.wikipedia.org/wiki/Time_complexity

### A Word Tree Implementation

To speed up the matching, the rules can be represented in a data structure that enables all the rules' patterns to be matched against the block of text in a single pass (i.e. in O(T) time). There are many ways to do this. One simple method (for patterns that are lists of words) is to organise the patterns into a word tree, where each arc in the tree is labelled with a word, and each node in the tree represents a string being the concatenation of the words on the arcs leading from the root to the node (with the root node representing the empty string). Each node in the tree points to one or more corresponding rules (or rule messages). FIG. 3 shows a word tree corresponding to the rules of FIG. 1.

To match a word tree with a block of text, start just before the first word in the text and use the words that follow in the text to traverse the tree. Display the messages associated with each traversed node in the tree. Then move past the first word in the text and repeat the process. The tree data structure means that the matching process will require O(T) operations because (assuming that matches are unusual) during each step, the tree traversal process usually won't move past the root. Even if it does move past the root, it will probably only go a few levels (note that the average pattern length above is small), which is effectively an O(1) operation. Overall, the time complexity is O(T) and this is R times faster than O(RT) for the simple implementation. If R is one million, it will be one million times faster.

As it is necessary to traverse the word tree for each word in the text, it's preferable that the word tree be stored in a high-speed storage medium such as random access memory (RAM) rather than a slower storage medium such as hard disk.

### Other Implementations

There are a variety of other ways of representing the rules that enables them to be applied to a text in a single pass.

Instead of organising the tree by words, the tree can be organised by characters so that each arc in the tree is labelled with a single character. This produces a much deeper tree, but with a much smaller average furcation.

In another method, instead of using a tree, each pattern (consisting of a sequence of words) is hashed and inserted into a hash table (with a link to the corresponding rule). At each position (word) in the text, the next word is hashed and looked up in the table. Then the next two words are hashed and looked up in the table. Then the next three words are hashed and looked up in the table. This continues for the next M words, where M is the maximum number of words in a pattern. The algorithm then moves to the next position (start of word) in the text and repeats. This method could also be applied at a character level.

In another method, patterns are required to be at least N characters long. One n-character substring is selected from each pattern as a representative of the pattern, and these are stored in a hash table that links to the corresponding rules. To match with a text, an N-character window is slid through the text one character at a time and the contents of the window hashed at each position and looked up in the table. The rules that are found there are then matched with the full pattern against the surrounding text.

In summary, there are many ways of representing a collection of rule patterns in a way that allows them to be matched against a text in a single pass of the text. What is important here is not the exact nature of the representation, but the observation that a representation is required to make the matching fast. These representations, whatever their form, will be referred to as “condensations”, and the process of creating representation from a set of rules will be referred to as “condensing”.

### Many Rulesets

Separate condensations can be constructed for different rulesets. Consider the situation where there are S rulesets, each consisting of an average of R rules. A user may wish to analyse a block of text using any one of the rulesets, and the system has to be ready to analyse a text using any one of them. This can be achieved by condensing each ruleset. FIG. 4 shows three rulesets, each of which contains five rules. A condensation has been constructed for each ruleset. When the user provides a block of text and selects a ruleset, the selected ruleset's condensation can be applied to the text immediately and at high speed.

### Blending Rulesets

In a system where users are creating a diversity of rulesets, it is advantageous to enable users to create blended rulesets that combine the rules of multiple rulesets. For example, if there is a ruleset X that contains rules that identify spelling errors, and another ruleset Y that contains rules that identify grammatical errors, it might be advantageous to create a ruleset Z that contains the contents of these two rulesets, with Z referring to X and Y rather than copying their contents. By referring to X and Y rather than copying their contents, the ruleset Z wouldn't need to be updated whenever X and Y change.

In practice, ruleset inclusions will form complex directed graph structures (FIG. 13). A single ruleset might be configured to directly and indirectly include the rules of hundreds of other rulesets.

Consider the situation where there are S rulesets, each consisting of an average of R rules. Suppose there are rulesets X, Y, and Z, each with 10,000 rules, where ruleset Y includes ruleset X, and ruleset Z includes ruleset Y. Invoking ruleset X will invoke just the rules in X, but invoking ruleset Y will invoke the rules in both X and Y. Invoking ruleset Z will invoke the rules in X, Y, and Z. FIG. 5 shows this example with a smaller number of rules in each ruleset.

One way to implement interconnected rulesets is to use the inclusion graph to compute the set of rules corresponding to each ruleset and then to construct a condensation for each ruleset. This will work, but because of the ruleset inclusions, there is likely to be significant duplication. In the example, if rulesets X, Y, and Z each contain 10,000 rules (directly), and each include each other, there would be three condensations, each of which would contain the patterns for the same 30,000 rules. As a result, condensations for 90,000 rules would have to be stored instead of condensations for 30,000 rules, a 66% memory inefficiency.

To save memory, a condensation can be constructed for each ruleset, with each condensation containing only the patterns corresponding to the rules (directly) contained within each ruleset. When the user presents a text for analysis by ruleset X, the condensation for X can be applied, then the condensation for Y (because X includes Y), and then the condensation for Z, in sequence with the results being combined to generate the text analysis. This is simple, but will take longer than if a single condensation had been constructed for ruleset X. If there are V rulesets (in the graph of rulesets leading from the ruleset being applied), then the analysis will require O(VT) operations. Unfortunately, in some ruleset graph structures in practice, V might be large.

It seems that a choice must be made between consuming large amounts of memory duplicating rules and consuming large amounts of processor time applying each ruleset separately.

The problem that the invention addresses is the problem of finding a condensation data structure for representing a group of interconnected rulesets that allows a text to be analysed by any given ruleset at high speed without using excessive memory. We have already seen a solution that minimises memory use (create a condensation for each ruleset and separately apply each rule in a ruleset's entire inclusion graph), but is slow, and a solution that minimises analysis time (create a condensation for each ruleset that includes the ruleset's entire inclusion graph), but uses lots of memory. The invention provides a condensation data structure that provides a practical compromise between these two extremes.

### SUMMARY

The invention solves the speed/memory trade-off problem by creating data structures that allow high-speed matching, but which can be stored in a compressed form to reduce memory use. This core idea is manifested in two different solutions to the speed/memory trade-off.

In the first solution, a single condensation is constructed for all rules, and this is applied to the block of text. Firings of rules that are not in the originally applied ruleset are then filtered out.

In the second solution, a separate condensation is constructed for each ruleset, but the condensations are compressed by eliminating most cross-condensation redundancy.

### Single Condensation Solution

In an aspect of the invention, two data structures are constructed.

First, a single “master” condensation (e.g. a word tree) is constructed that contains the patterns of every rule in the universe of rules (the set of all rules in the system).

Second, each ruleset is analysed (taking into account its inclusion other rulesets) and a boolean array (indexed by rule number) is created for each ruleset indicating whether each rule in the universe of rules is in the ruleset. Each ruleset ultimately just defines a subset of the universe of rules, so the boolean array embodies the entire semantics of the ruleset.

FIG. 6 shows this aspect of the invention for two rulesets X and Y, where the condensation takes the form of a word tree. Ruleset X contains two rules and ruleset Y contains three rules. A single master tree has been created that incorporates all five rules. The master tree can be used as a basis for applying either or both of ruleset X and ruleset Y to a block of text. Each ruleset has a corresponding boolean vector that represents the rules it contains.

To analyse a block of text using a ruleset S, the master word tree is applied to the block of text (as described earlier), resulting in a set of matches that bind rule instances to the text. Concurrently with this process, or as a second phase, the ruleset's boolean array is used to eliminate matches by rules not in ruleset S. The surviving matches form the report.

This single-condensation solution has the advantage that there is no duplication in condensations. Each rule is stored in condensed form exactly once. The matching process will proceed at high speed because there is only one condensation to apply (not V condensations as described earlier). The filtering of matches using the boolean vectors will be fast because boolean vector lookup is fast.

The single-condensation solution is very useful, but has two disadvantages. First, the first phase might generate a list of matches far larger than the invoked-ruleset's condensation alone would generate, so that there are an excessive number of boolean array lookups to perform. Second, the boolean arrays of large numbers of rulesets might use up too much memory.

The first problem is difficult to solve because generating matches for the patterns of all the rules is what the data structure is designed to do. The severity of this problem in practice will depend on the content of the rulesets and the speed at which the boolean array lookups can be performed.

The second problem can be addressed by observing that, while the set of boolean arrays for the rulesets that include each other are likely to be very large (each will contain as many bits as rules in the universe of rules), they will contain a lot of redundancy. For a start, they might simply be sparse (far more of one boolean value than the other), which will enable them to be compressed using conventional bit vector compression. There might also be inter-vector redundancy. For example, if there are 2000 rules in the universe of rules and a ruleset X that contains rules numbered 1 to 1000 and a ruleset Y that contains rules numbered 1001 to 2000, then if ruleset Z includes X and Y, then the first half of Z's boolean array will be the same as the first half of X's array, and the second half will be the same as the second half of Y's array. This means that Z's boolean array can be compressed to use almost no spade at all (e.g. by pointing to the boolcan arrays for X and Y rather than copying them).

By creating a single condensation of all rules, creating a boolean vector for each ruleset, and compressing the boolean vectors, that is compressed, the aspect of the invention achieves a practical compromise between optimising speed and space.

### Multiple Condensation Solution

In an aspect of the invention, a separate condensation is created for each ruleset, but the condensations are stored in a way that eliminates most cross-ruleset redundancy. This is done preferably without significantly impacting speed.

In an aspect of the invention where each pattern is a word list, each ruleset is condensed into a word tree. FIG. 3 shows an example word tree condensation that has been constructed from the rules shown in FIG. 1. Whenever a new word tree is created, checks are performed (e.g. using an index or a content-addressed store) to see if the tree being created shares subtrees with the word trees of any existing rulesets. If there are two identical subtrees, the new tree can simply point to the old ruleset's subtree. FIG. 25 shows an example where a new tree must be constructed that contains the union of two other trees. In this example, by referencing existing subtrees, the new tree shares all but the root node, yielding a significant space saving furthermore there is no reduction in the speed of construction of the word tree.

In an aspect of the invention, where each pattern is a wordlist, each ruleset is condensed into a hash table whose keys are patterns and whose values are messages (or rule identities). The hash tables are then compressed by storing each hash table in the leaves of its own dedicated digital search tree, and then storing the digital search trees of the hash tables in a redundancy-reducing content-addressed store (FIGS. 16 to 19). The net effect will be to eliminate much of the storage redundancy that exists within the set of ruleset condensations.

In a broad aspect of the invention a method for generating annotations for a block of text T using a ruleset S, the method comprising the steps of: (a) storing a plurality of rulesets containing a plurality of rules created by a plurality of entities, a plurality of rules comprising a text pattern and a message; (b) representing a plurality of rulesets in a data structure D that allows any ruleset R to be applied to a block of text to generate annotations such that the operation has a time complexity less than O(RT); and (c) using D to apply a particular ruleset S to T to generate annotations.

### TERMINOLOGY

Annotation—The association of a rule instance to a block of text.
Block of Text—A sequence of zero or more characters.
Condensation—A data structure created from a ruleset that can match the rules in the ruleset against a block of text at high speed (typically in a single pass of the text).
Condense—The process of creating a condensation from a ruleset.
Document—A block of text that possibly also carries associated metadata such as font and style information.
Entity—A legal person, being a person or a corporation or similar.
Fire—A rule fires when its pattern matches some part of a block of text and its message is incorporated into the report.
Firing—A particular instance of the incorporation of a particular rule's message into the report.
Inclusion List—An ordered list of commands that define rules and rulesets to be included in a ruleset.
Match—A rule matches part of a text block if its pattern matches that part of the text block. A rule can match without firing.
Matchings—A collection of annotations.
Message—A body of information associated with a rule. A rule's message can take various forms (e.g. text, audio, video), and these can be incorporated into a report when a block of text is analysed.
Pattern—A formal constraint on text that can be tested at any point in a block of text to determine whether the pattern matches at that point. An exception is some kinds of pattern that will either match or not match an entire block of text rather than match at a particular position within a block of text.
Priority—A number assigned to a rule or ruleset by a ruleset. A higher priority indicates greater importance. Priorities can be used to rank annotations.
Rating—A numerical rating of a User, Rule, or Ruleset accumulated over time from the performance of the User, Rule, or Ruleset. The term is also used to describe a particular rating of a particular object by a particular user.
Regular Expression—An expression that specifies a set of strings, typically in a form that is more concise than an enumeration of the set. A regular expression can be used as a pattern, and matches if the string being matched is a member (or, in some matching contexts, contains a member) of the regular expression's set of strings. In this document, the term has the same meaning as it does in the field of Computer Science and this meaning is found in Wikipedia at http://en.wikipedia.org/wiki/Regular_expression
Report—A collection of annotations of a block of text. A report is usually created for presentation to a user. Reports can exist in a wide variety of forms.
Representing—is represented when it is encoded in a way that enables the information to be retrieved. Information can be represented in many different ways, with different ways having differing advantages and disadvantages. For example, one representation might use less space, but provide slower retrieval, whereas another representation might provide fast retrieval, but use much more space. Rules, rulesets, and pluralities of rulesets can be represented in many different ways, some of which allow the rules or rulesets to be applied to a block of text faster than do other representations.
Rule—A rule comprises a text pattern and a message.
Rule Instance—A rule instance is bound to a position in a block of text to form an annotation,
Rule Number—A unique number assigned to each rule.
Ruleset—A collection of one or more rules. Rulesets are sets because each ruleset is a subset of the universe of rules.
Storing—Information, is stored when it is held in a computer storage medium of some kind, such as, without limitation, CPU memory, flash memory, and disk memory.
Text—Another name for a Block of Text.
Universe of Rules—The set of all rules in the system.
User—The person who is using an embodiment of the invention.

### BRIEF DESCRIPTION OF FIGURES

FIG. 1 shows a short list of pattern/message rules;

FIG. 2 shows an analysis where the rules of FIG. 1 have been applied to a block of text. generating a report of annotations to assist the user;

FIG. 3 shows the rules of FIG. 1 represented as a word tree;

FIG. 4 shows how a word tree can be constructed for each ruleset;

FIG. 5 shows three rulesets called X, Y, and Z that have some inclusion relationships. The R letters represent rules. The small circles represent inclusions;

FIG. 6 shows an example of the single condensation solution. Here the condensation takes the form of a word tree. A single master tree has been created that incorporates the rules of two rulesets. Each ruleset has a corresponding boolean vector that indicates which rules are in the ruleset;

FIG. 7 shows a boolean array of length 27 and a corresponding 3-furcation 3-level digital search tree with 27 leaves, each leaf of which stores a Boolean;

FIG. 8 shows the digital search tree of FIG. 7 with the leaf nodes deleted and their values moved into arrays stored in the nodes at the next level up;

FIG. 9 shows the digital search tree of FIG. 8 with its lowest nodes replaced by hash values of the lowest nodes and with the unique lowest nodes stored in a hash table. This structure eliminates the storage duplication of all lowest-level nodes (HA, HB, HC);

FIG. 10 shows the digital search tree of FIG. 9 with the next level up converted into an array of hash values;

FIG. 11 shows the digital search tree of FIG. 10 with the next level up converted into an array of hash values;

FIG. 12 shows the digital search tree of FIG. 11 with the root node itself stored in the table;

FIG. 13 shows a collection of rulesets (containing rules shown as R) whose inclusion relationships form a directed graph structure. An arrow indicates that a ruleset includes the contents of the pointed-to ruleset;

FIG. 14 shows a collection of rulesets (whose rules are represented by letters) whose inclusion relationships form a directed graph structure. The statements at the bottom show the rules that each ruleset contains (taking into account its inclusions);

FIG. 15 shows how the contents of two hash tables can be combined to generate a third hash table;

FIG. 16 shows the hash table combination of FIG. 15, except that here each hash table has been split into fixed-length (here three) pieces, which are then referred to by an array of reference. When the two tables are merged to generate a third table, the third table can point to the pieces of the first two tables so as to reduce storage duplication;

FIG. 17 shows the structure of FIG. 16 extended from a single-level array of pieces to a digital search tree of pieces;

FIG. 18 shows FIG. 17 but with each node in the tree labelled with the hash of its contents;

FIG. 19 shows the three trees of FIG. 18 represented in a content-addressed key/value store that maps hash values to three-element;

FIG. 20 shows how two rulesets, whose patterns are phrases, are likely to interleave significantly when merged into the same table;

FIG. 21 shows the merging of two sparsely-populated tables. An empty cell means that the table is empty there;

FIG. 22 shows the merging of a sparsely-populated table with a densely-populated table.

FIG. 23 shows the merging of two densely-populated tables;

FIG. 24 shows FIG. 19 with reference counts associated with each hash;

FIG. 25 shows two rulesets named X and Y, their condensations (in the form of word trees) and a new ruleset Z that contains X and Y and whose condensation has been created by referencing subtrees of X and Y's condensations;

FIG. 26 shows a hierarchy of data structures that can be used to represent rulesets in a form that eliminates much space redundancy;

FIG. 27 shows a hierarchy of data structures that can be used to store priority vectors in a space-efficient form; and

FIG. 28 shows the creation of data structure D from a plurality of stored rulesets and the subsequent use of D to apply ruleset S to a block of text T to generate annotations.

### DETAILED DESCRIPTION OF FIGURES

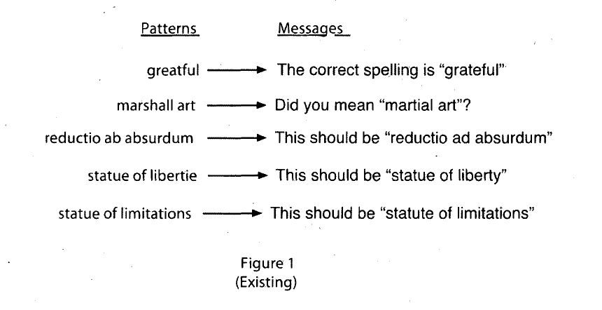

FIG. 1 shows a short list of pattern/message rules. When a pattern matches in a block of text, the corresponding message can be displayed to assist the user.

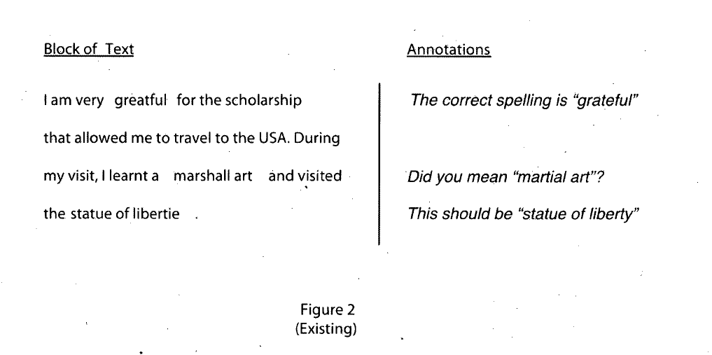

FIG. 2 shows an analysis where the rules of FIG. 1 have been applied to a block of text, generating a report of annotations to assist the user. Each annotation is bound to a particular place in the text where a rule's pattern matched the text (here shown in bold). There are many ways in which a report could be displayed.

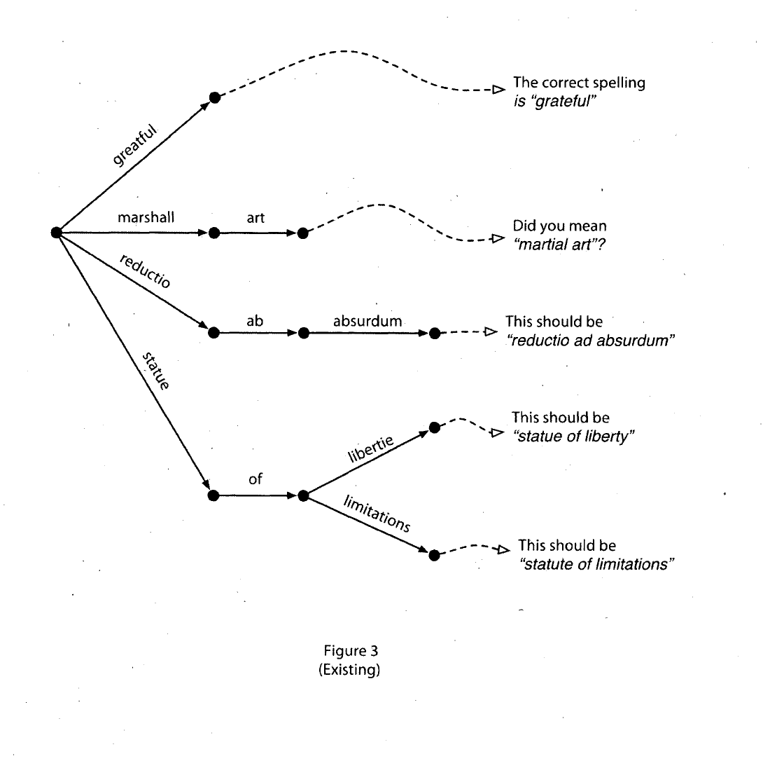

FIG. 3 shows the rules of FIG. 1 represented as a word tree. Each node in the tree represents a string (to avoid clutter, these strings are not shown), with the root node being the empty string. Each arc on the tree is labelled with a word that is appended to its parent node's string to generate its child node's string. On nodes corresponding to rule patterns, the rule message is attached. Word trees allow a block of text consisting of words to be matched quickly against a collection of rules (whose patterns are lists of words) by traversing the word tree (starting from the root) at each position in the block of text (not shown here).

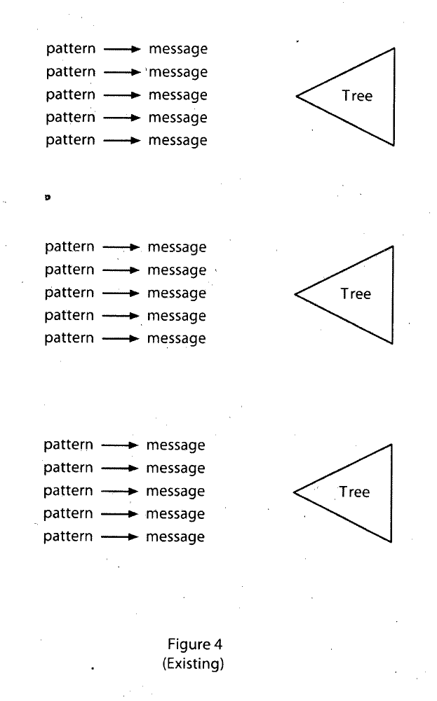

FIG. 4 shows how a word tree can be constructed for each ruleset. This figure shows three rulesets, each of which contains five rules. A word tree has been constructed for each ruleset. In this figure, each word tree is represented by a triangle. Each word tree is similar, in form, to the word tree depicted in FIG. 3.

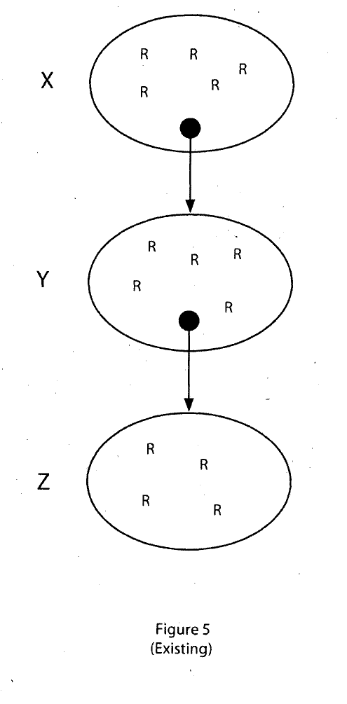

FIG. 5 shows three rulesets called X, Y, and Z that have some inclusion relationships. The R letters represent rules. The small circles represent inclusions. Ruleset X includes ruleset Y. Ruleset Y includes ruleset Z. This means that ruleset Z contains just its own four rules, whereas ruleset Y contains nine rules being its own rules and ruleset Z's rules. Ruleset X contains 14 rules being its own rules and also the rules of ruleset Y (which includes the rules of ruleset Z).

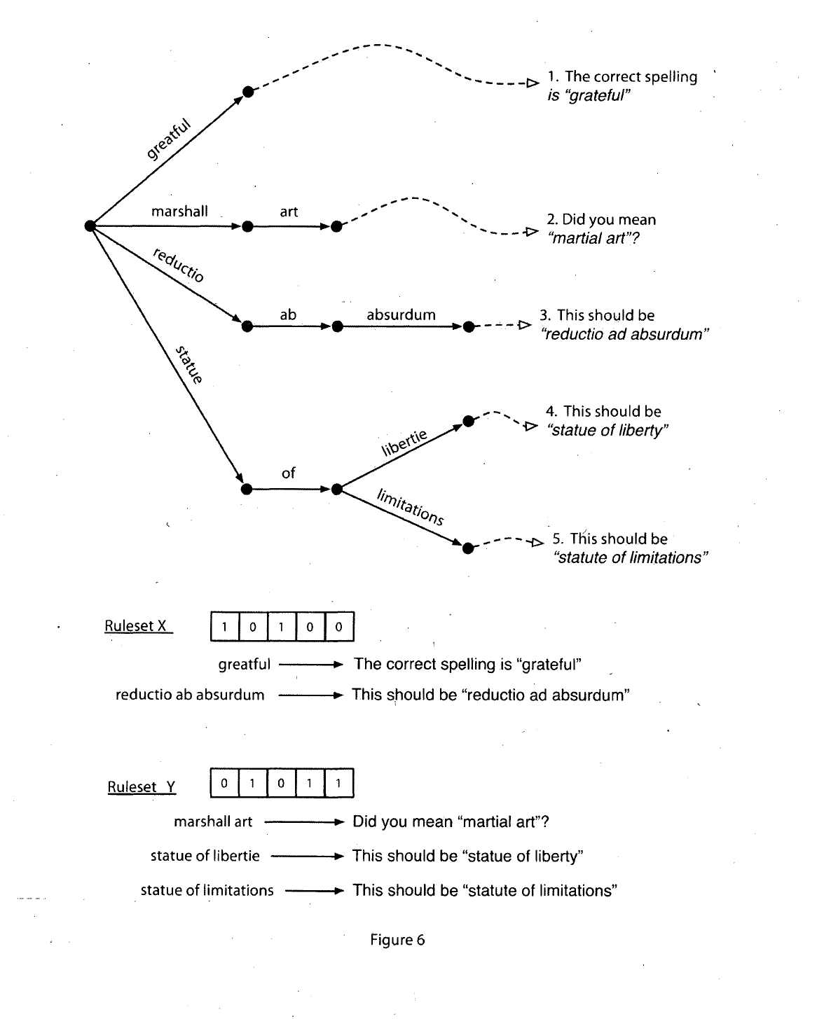

FIG. 6 shows an example of the single condensation solution. Here the condensation takes the form of a word tree. In this example, there are two rulesets X and Y. Ruleset X contains two rules and ruleset Y contains three rules. A single master tree has been created that incorporates all five rules. Each ruleset has a corresponding boolean vector that indicates which rules are in the ruleset. To apply a ruleset S to a block of text, the master tree is applied to the block of text to generate a collection of annotations. Concurrently, or subsequently, the annotations are filtered by eliminating each annotation whose corresponding rule has a 0 entry in the boolean vector of the ruleset S being applied.

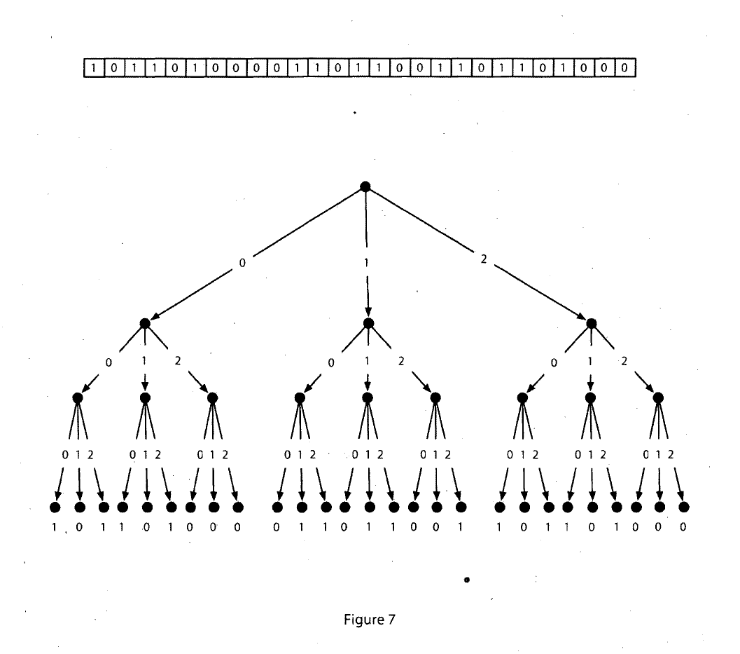

FIG. 7 shows a boolean array of length 27 and a corresponding 3-furcation 3-level digital search tree with 27 leaves, each leaf of which stores a boolean. Array indices can be converted to tree traversals by representing the index as a base 3 number and then using the successive digits to traverse the tree. For example, the index decimal 5 in base three has the digits 012 and these digits would be used to traverse the tree from the root. The digital search tree is more complicated than the array, but provides a foundation for eliminating redundancy.

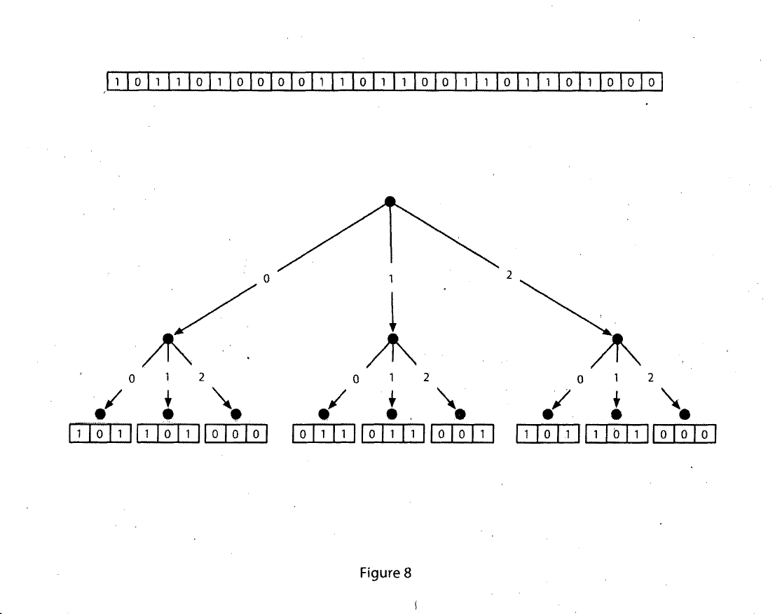

FIG. 8 shows the digital search tree of FIG. 7 with the leaf nodes deleted and their values moved into arrays stored in the nodes at the next level up. There are still 27 (virtual) leaf nodes, but they are stored in the nodes one level above where the leaves were. As the space overhead of organising to store leaves that hold just one bit is relatively very high, this optimised structure can save a lot of space in practice.

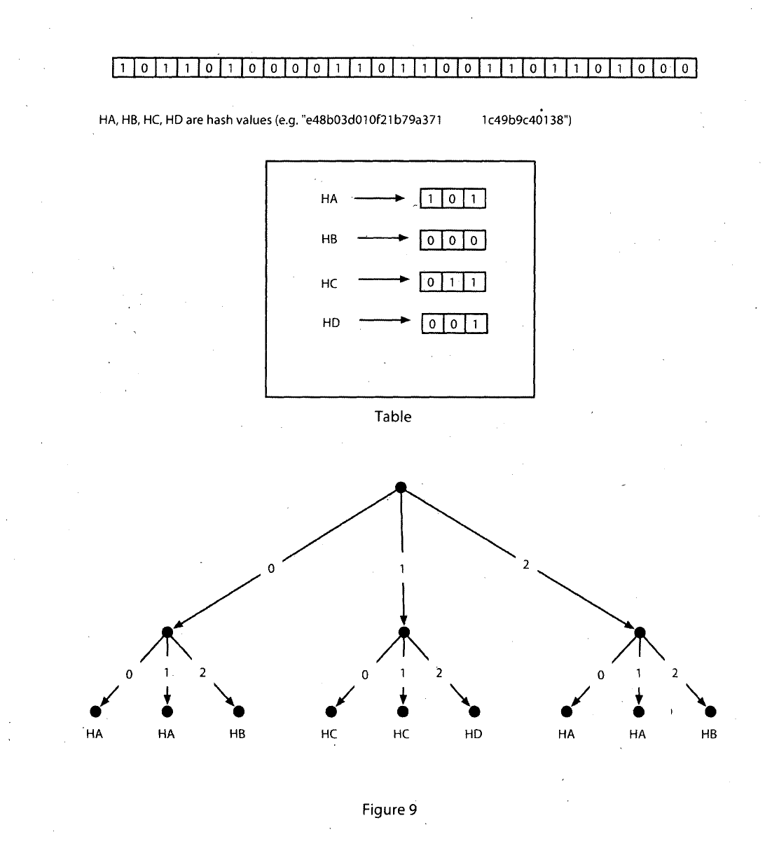

FIG. 9 shows the digital search tree of FIG. 8 with its lowest nodes replaced by hash values of the lowest nodes and with the unique lowest nodes stored in a hash table. This structure eliminates the storage duplication of all lowest-level nodes (HA, HB, HC).

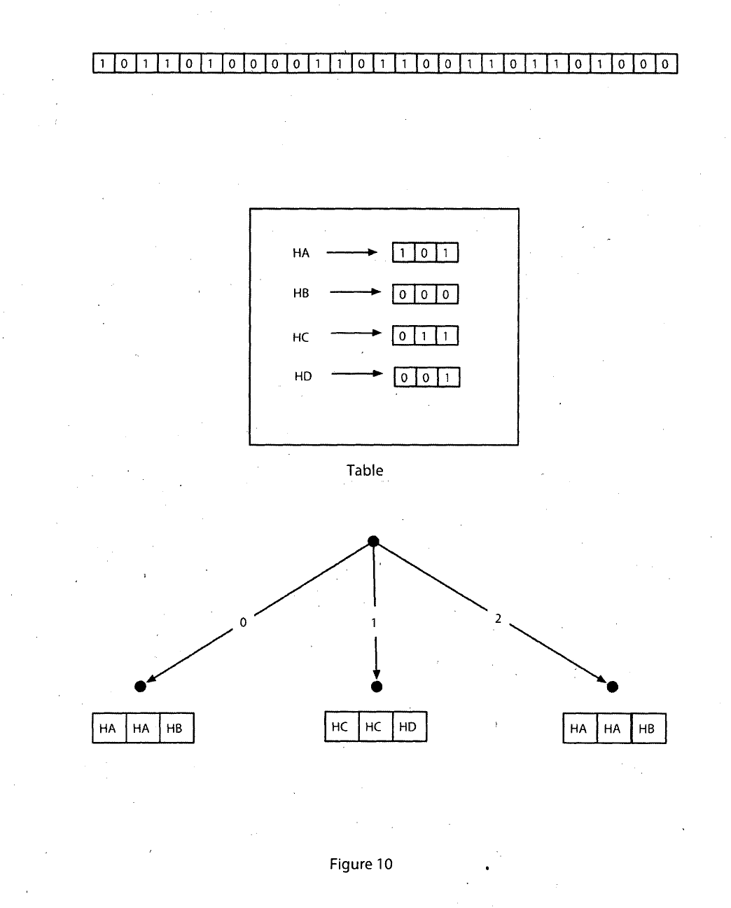

FIG. 10 shows the digital search tree of FIG. 9 with the next level up converted into an array of hash values.

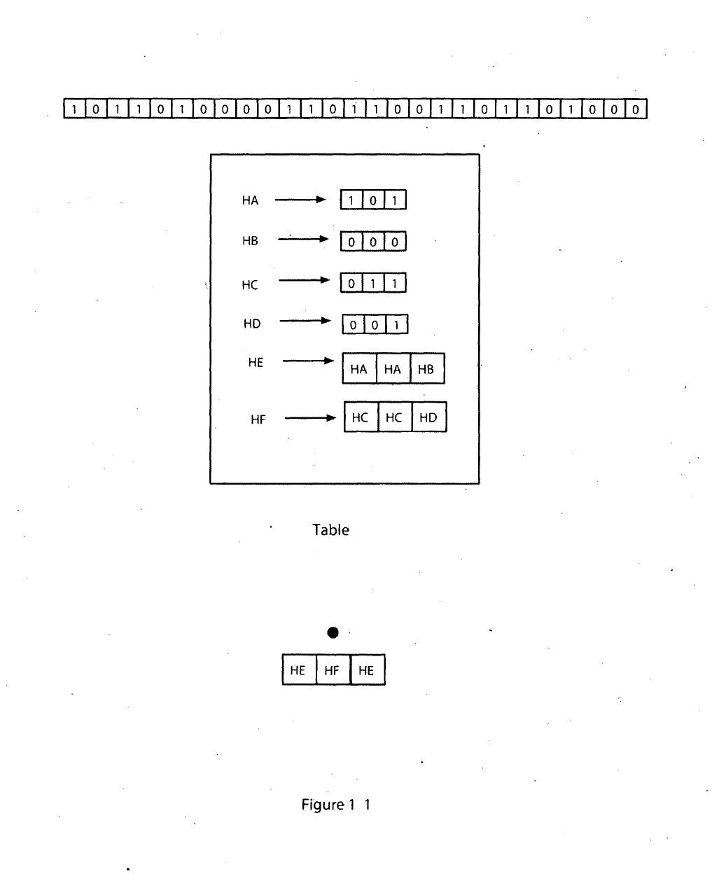

FIG. 11 shows the digital search tree of FIG. 10 with the next level up converted into an, array of hash values. Note that the leftmost and rightmost nodes in the reduced tree of FIG. 10 had identical content, and so these two nodes are stored in the single table entry with hash HE.

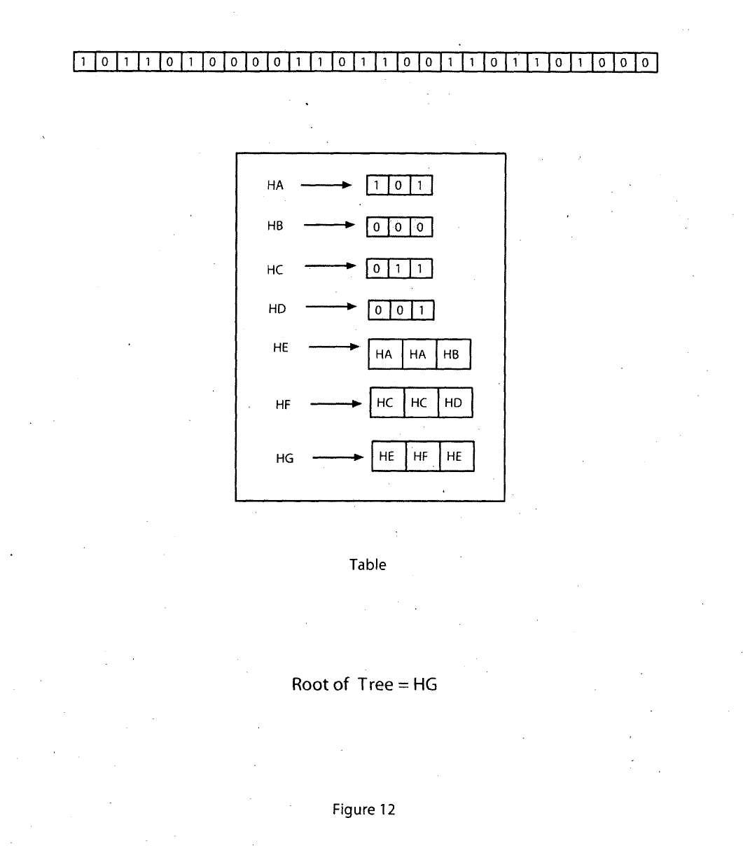

FIG. 12 shows the digital search tree of FIG. 11 with the root node itself stored in the table. This is the final state in the transformation of the representation of the tree from a tree to representation as a collection of content-addressed nodes in a table. The root of the tree is now represented as a single hash value of HG. In this structure, all nodes are stored in the table, including the root node, and all identical nodes are stored just once in the table.

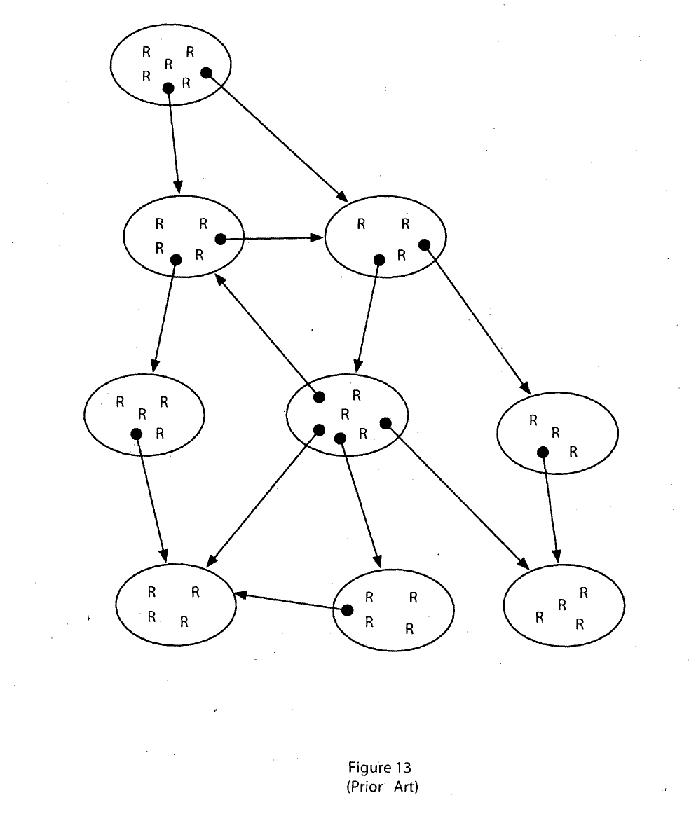

FIG. 13 shows a collection of rulesets (containing rules shown as R) whose inclusion relationships form a directed graph structure. An arrow indicates that a ruleset includes the contents of the pointed-to ruleset. Inclusions are transitive, so if a ruleset X includes a ruleset Y, X includes the rules directly in Y and the result of Y's inclusions too. In practice, it makes most sense for these graphs to be directed acyclic graphs, but directed cyclic graphs could be accommodated so long as cycles are sensibly handled by the software.

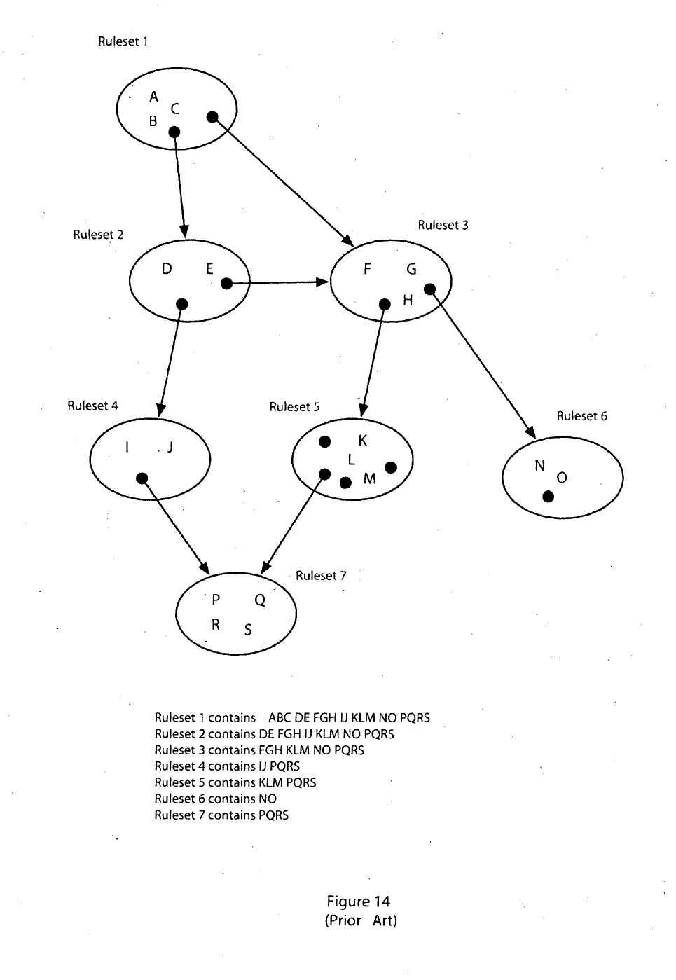

FIG. 14 shows a collection of rulesets (whose rules are represented by letters) whose inclusion relationships form a directed graph structure. An arrow indicates that a ruleset includes the contents of the pointed-to ruleset. Inclusions are transitive, so if a ruleset X includes a ruleset Y, X includes the rules directly in Y and the result of Y's inclusions too. The statements at the bottom show the rules that each ruleset contains (taking into account its inclusions).

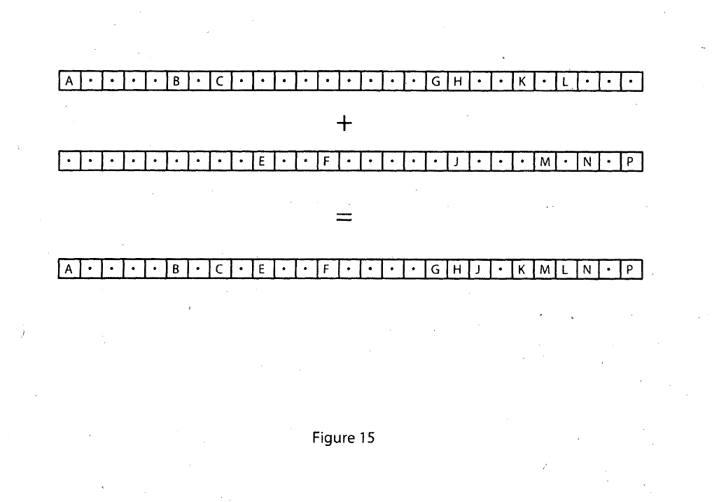

FIG. 15 shows how the contents of two hash tables can be combined to generate a third hash table. Here, each hash table is represented as an array. Each entry in each table's array is either a letter, which represents a record of information (e.g. a rule), or a dot, which represents an empty position. As the two tables are sparse, the two tables can be combined simply by processing corresponding positions in the two source array. Two dots results in a dot. A dot and a letter results in the letter. Two letters results in the first letter, with the other letter finding a new home in the next empty position (hash table overflow).

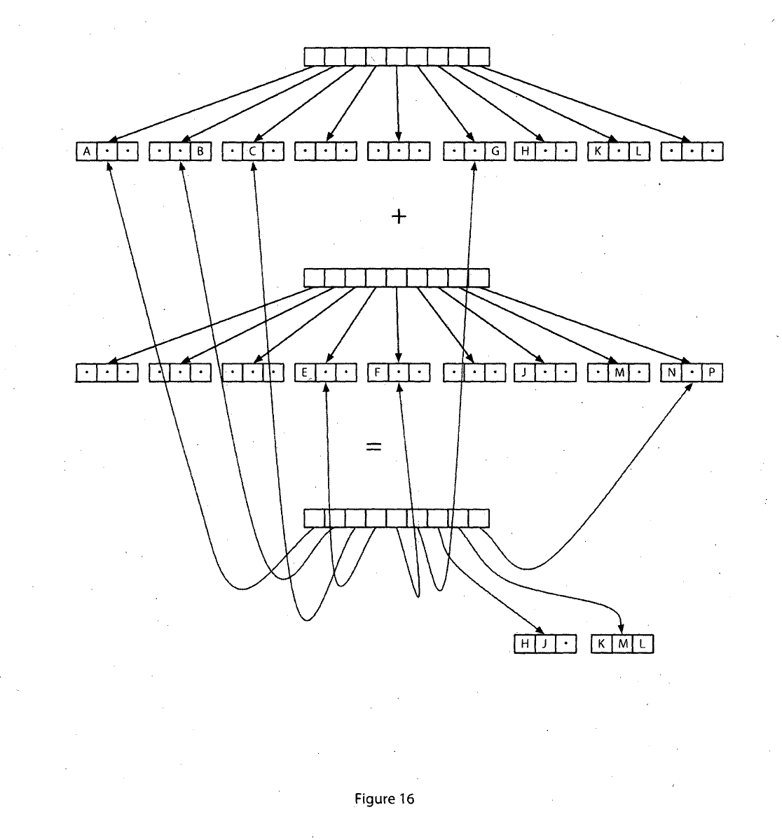

FIG. 16 shows the hash table combination of FIG. 15, except that here each hash table has been split into fixed-length (here three) pieces, which are then referred to by an array of references. When the two tables are merged to generate a third table, the third table can point to the pieces of the first two tables so as to reduce storage duplication. As can be seen, in most cases, the third table can reference, rather than copy, the existing data. The exceptions are in the case where the piece “H••” and “J••” must be combined. This generates “HJ•” which is a new unique triplet. Similarly, combining the pieces “K•L” and “•M•” generates “KML”—another new unique triplet. In summary, the ability to point to pieces has resulted in a saving of 7/9 of the storage space that would otherwise be required for the third table. Note that to avoid confusion and focus the reader on the construction of the third tree, no attempt has been made in this figure for the first two trees to share their common components. The main disadvantage of this data structure is that the size of the array of references representing the third table will be the same size regardless of the extent of similarity between the first two tables.

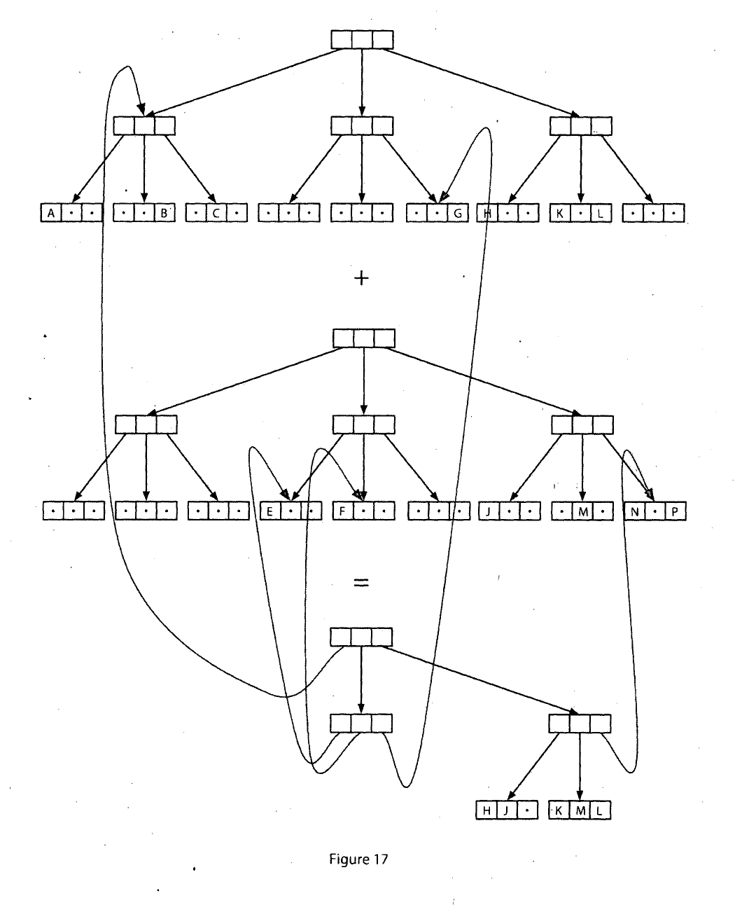

FIG. 17 shows the structure of FIG. 16 extended from a single-level array of pieces to a digital search tree of pieces. Each tree stores an array of 27 elements indexed [0,26] with the digits of the base-three representation of an index being used to move down the tree to the index's storage cell in a leaf node. As in FIG. 16, the combined third hash table can refer to pieces of the existing two trees, but unlike in FIG. 16, the third table's tree can refer to higher-level nodes in the tree, not just leaf nodes. Here, the entire left third of the combined tree is identical to the entire left third of the first tree, so can simply be pointed to. This saves the third tree the space of having to store three references for that third (just one). The second third of the tree is not identical to a third of either of the first two trees, but its three subtrees are. In the case of the rightmost third, the rightmost triplet of the three components can be referenced, but the other two require the creation of new unique leaf nodes.

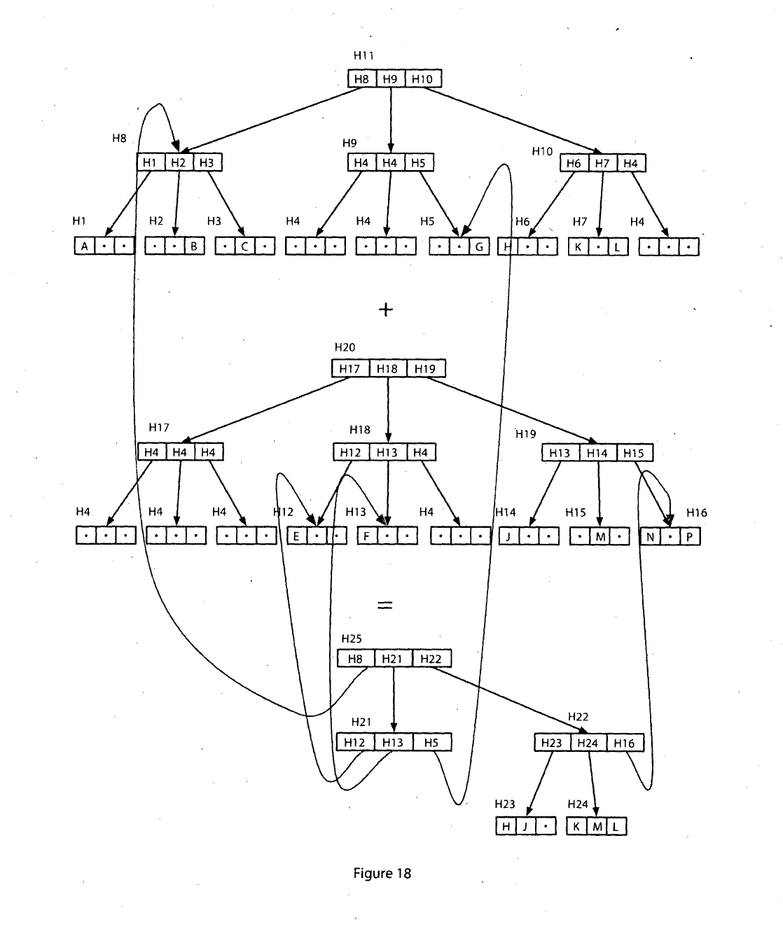

FIG. 18 shows FIG. 17 but with each node in the tree labelled with the hash of its contents. Hashes are represented as H1, H2, etc rather than their actual values. Each non-leaf node stores the hashes of its child nodes.

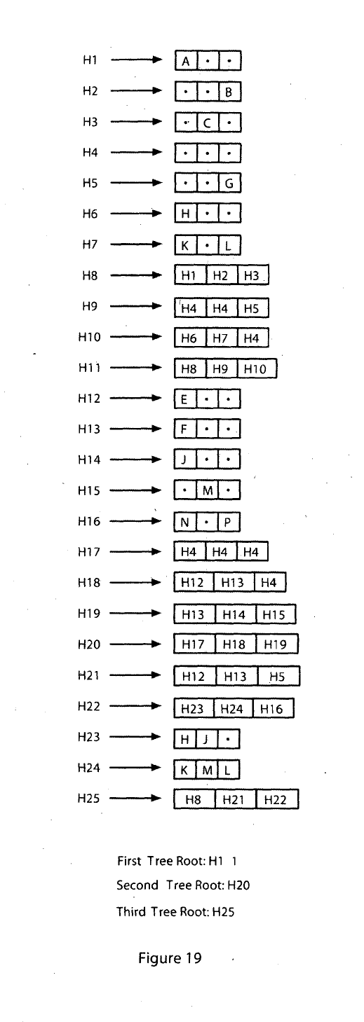

FIG. 19 shows the three trees of FIG. 18 represented in a content-addressed key/value store that maps each hash value to a three-element array. The store eliminates the duplicate storage of all common nodes in the trees. The root of each tree is now stored simply as a hash value being the hash of the root node. In summary, a hash table is represented using a digital search tree whose nodes are stored in a redundancy-eliminating content-addressed store.

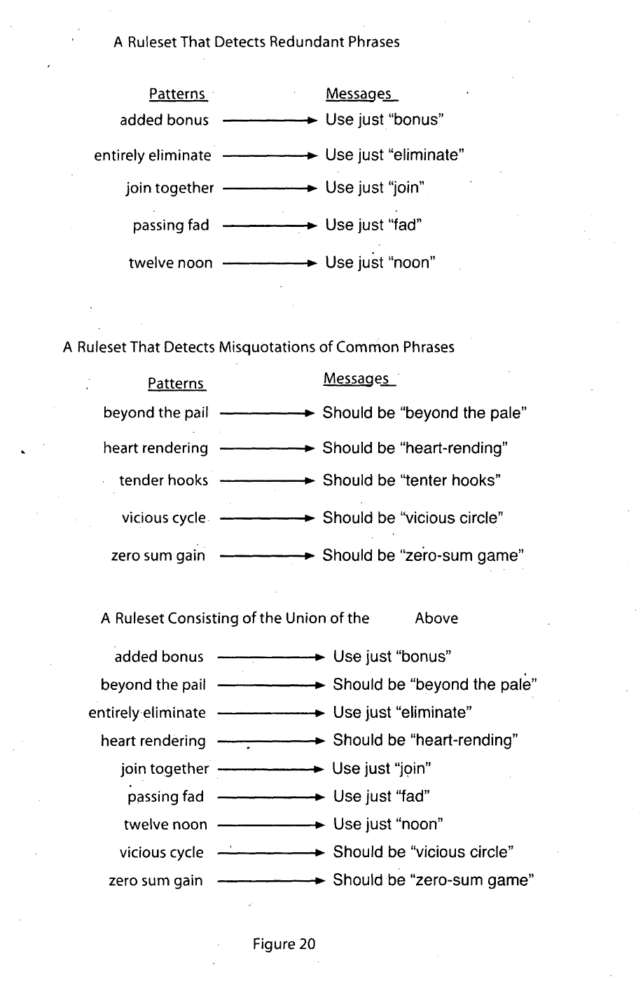

FIG. 20 shows how two rulesets, whose patterns are phrases, are likely to interleave significantly when merged into the same table. The figure shows one ruleset that contains rules for detecting redundant phrases, and another ruleset that contains rules for detecting misquotations of common phrases. Both rulesets have their rules sorted by their patterns. Each ruleset contains rules whose patterns are scattered throughout the alphabet, so when the two rulesets are merged, the rules of the two rulesets mingle rather than clumping together separately, as would happen if, for example, the redundancy ruleset only had patterns starting with the letters A-M and the misquotation ruleset only had patterns starting with the letters N-Z. This intermingling has implications for data structures that eliminate redundancy in the storage of related rulesets.

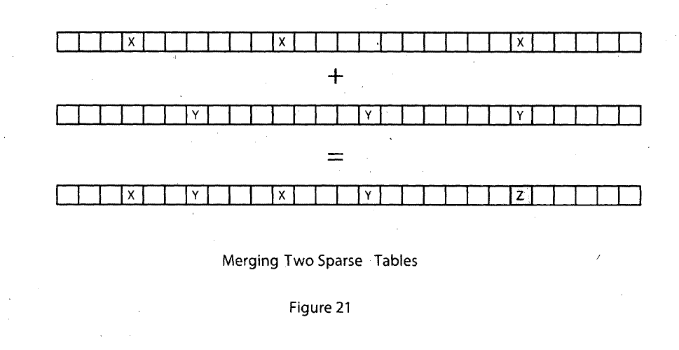

FIG. 21 shows the merging of two sparsely-populated tables. A cell can represent a priority value or a group of priority values (e.g. a bucket). An empty cell means that the table is empty there. The cells with X are cells in the first table that contain an entry. The cells with Y are cells in the second table that contain an entry. The merging of the two sparse tables generates another (less) sparse table containing Xs and Ys except for one overlap which generates a new cell Z. If these tables were represented using a content-addressed data structure, most of the merged table would be stored as references to components of the other tables.

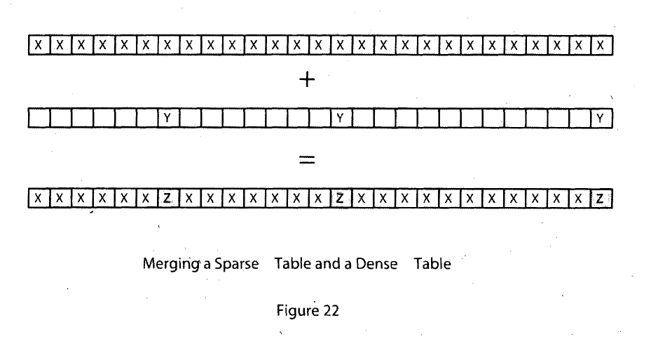

FIG. 22 shows the merging of a sparsely-populated table with a densely-populated table. The cells with X are cells in the first table that contain an entry. The cells with Y are cells in the second table that contain an entry. The merging of the two sparse tables generates a dense table that is almost identical to the first table except for some changes caused by the sparse table, shown as Z. If these tables were represented using a content-addressed data structure, most of the merged table would be stored as references to components of the dense table.

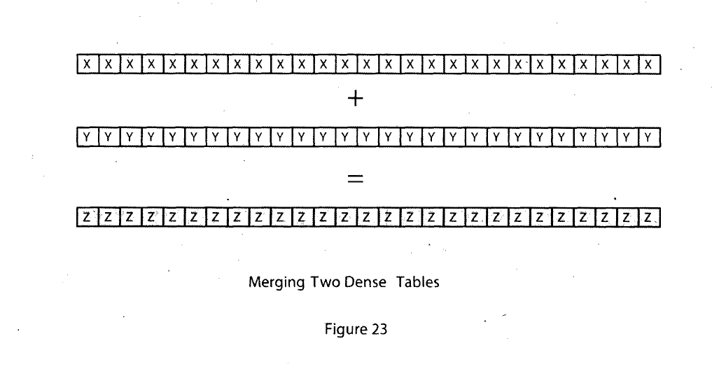

FIG. 23 shows the merging of two densely-populated tables. The cells with X are cells in the first table that contain an entry. The cells with Y are cells in the second table that contain an entry. The merging of the two dense tables generates a dense table contains mostly new material (Z) consisting of the merges of each cell. If these tables were represented using a content-addressed data structure, most of the merged table would be fresh material.

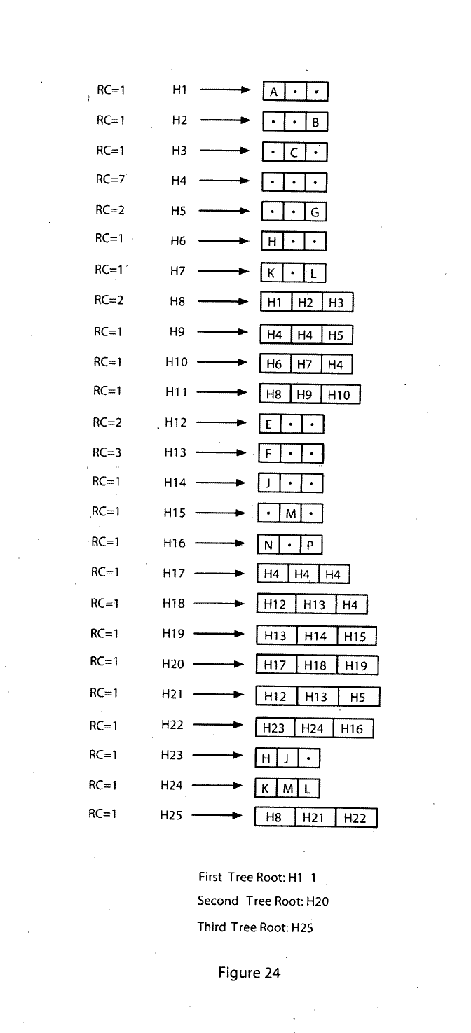

FIG. 24 shows FIG. 19 with reference counts associated with each hash. The reference count of each hash is the number of references that exist to the hash. If the data structure is being changed and the reference counts are updated with the changes, reference counts allow unused nodes to be detected (when the reference count is zero) and deleted.

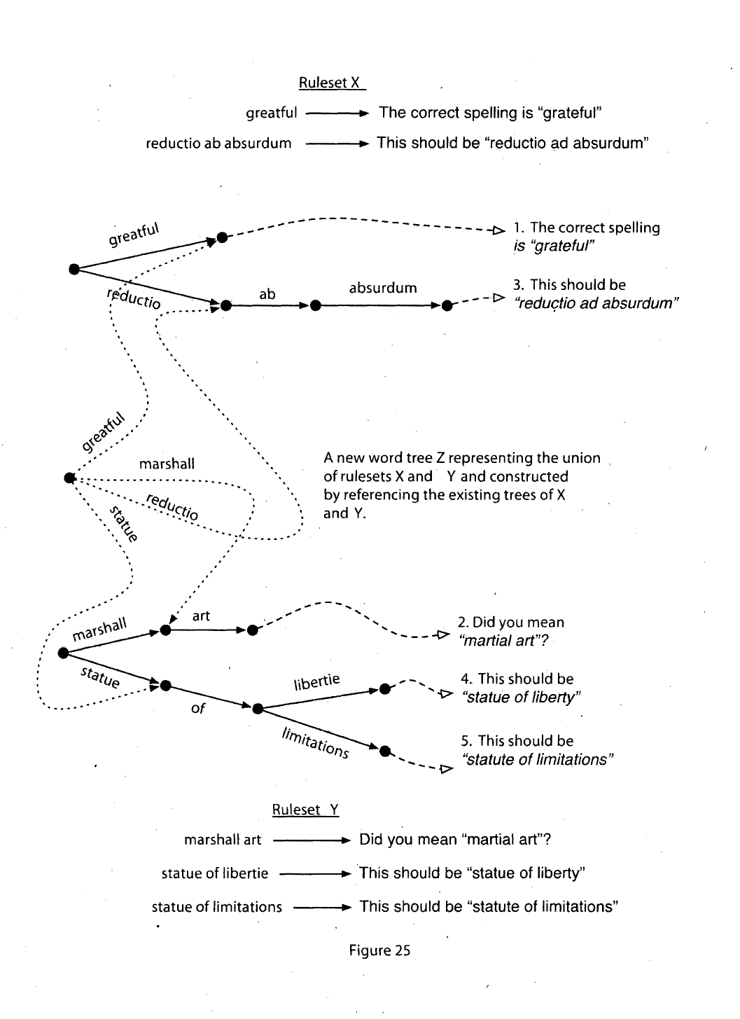

FIG. 25 shows two rulesets named X and Y. Ruleset X contains two rules and ruleset Y contains three rules. Each ruleset has been condensed into a word tree to speed up matching. A new ruleset Z includes ruleset X and ruleset Y. To save space, instead of creating a new word three for Z (exactly as shown in FIG. 6), Z's tree is constructed by referencing the existing subtrees of ruleset X and ruleset Y's condensations. Here, ruleset Z's entire tree can be constructed by referencing first level nodes in the other trees, but this might not always be possible, requiring Z's non-referenced part of its tree to be constructed beyond the root.

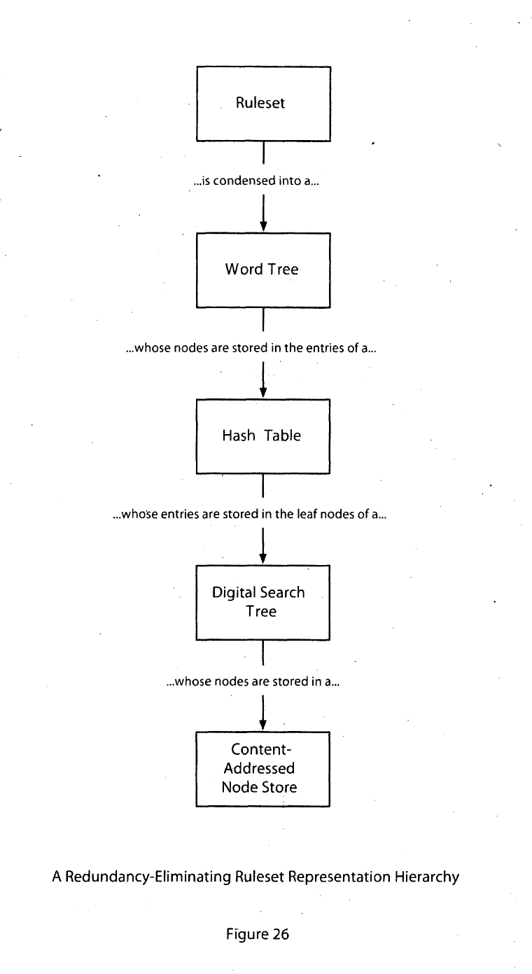

FIG. 26 shows a hierarchy of data structures that can be used to represent rulesets in a form that eliminates much space redundancy. Each data structure presents a clean abstraction to the layer above it, allowing the complexity to be intellectually manageable. The hierarchy shows how a single ruleset is represented in the hierarchy, but the purpose of the hierarchy is to eliminate the redundancy when multiple related rulesets are stored together. The hierarchy operates as follows. A ruleset is represented as a word tree (e.g. see FIG. 3). The nodes in the word tree are stored in entries of a hash table with the hash table key being a pattern and the hash table value being a message or rule identity. The hash table is then stored in the leaves of a digital search tree whose keys are the hash table indices. Finally, the nodes in the digital search tree are stored in a content-addressed node store that eliminates the duplicate storage of identical nodes. The entire data structure hierarchy allows large numbers of rulesets with shared content to be represented in a form that simultaneously allows high-speed traversal of their corresponding word trees while eliminating the duplicate storage of much of their shared content.

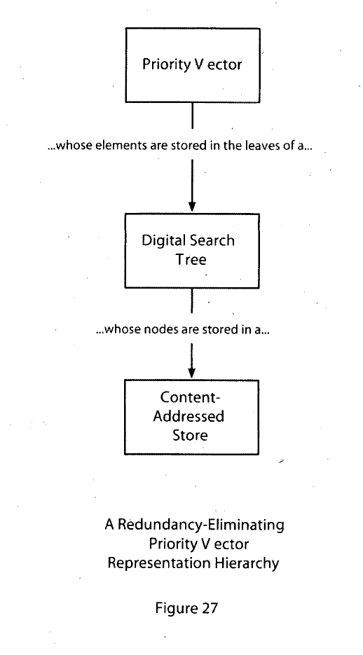

FIG. 27 shows a hierarchy of data structures that can be used to store priority vectors in a form that eliminates much space redundancy that arises where priority vectors share spans of data. Starting with a priority vector, which is an array of priority values, a digital search tree is created with enough leaf nodes to store all the entries in the priority vector. All the nodes in the digital search tree (leaf nodes and non-leaf nodes) are then stored in a content-addressed store. FIGS. 16 to 19 show how a priority vector is stored in a content-addressed store.

### DETAILED DESCRIPTION

### The Pattern Space does not Naturally Yield Useful Clustering

It is useful to identify insights into the domain in which the invention operates so as to identify challenges and opportunities that can assist in shaping the invention. One insight that is important is that when two rulesets are merged, it is very likely that the patterns of the two rulesets will interleave significantly in the (alphabetically-sorted) pattern space. The reason for this is that while each rulesets (created by users) will have a coherent nature, that coherent nature is not likely to result in the clumping in the ruleset's rule's patterns within the pattern space. This can be illustrated with an example.

FIG. 20 shows how two rulesets, each of whose patterns consists of a sequence of one or more words. One ruleset contains rules for detecting redundant phrases. The other ruleset contains rules for detecting misquotations of common phrases. Both rulesets have their own coherent nature, but this nature does not result in each ruleset's rules' patterns clumping in the pattern space. Instead, each ruleset contains rules whose patterns are scattered throughout the alphabet, so when the two rulesets are merged, the rules of the two rulesets mingle in the pattern space rather than clustering together separately, as would happen if, for example, the redundancy ruleset only had patterns starting with the letters A-M and the misquotation ruleset only had patterns starting with the letters N-Z. If such clustering occurred, a new merged ruleset could point to a small number of subtrees in the rulesets from which it was created.

This probable mingling in the pattern space of any two rulesets that are merged means that representing the rulesets in a search tree whose keys exist in the pattern space is unlikely to result in more common subtrees arising (between rulesets) than is likely to arise at random. Patterns as keys do not deliver any particular payload over other keyspaces. This is an important insight in the data structure design.

### Probably No Key Space Naturally Yields Useful Clustering

FIG. 20 gives an example that shows why it is unlikely that the pattern space will yield useful clustering. This leads to the obvious question: What space might lead to useful clustering? Unfortunately, it is not clear that any keyspace that we could choose will yield useful clustering.

### Merging Sparse and Non-Sparse Rulesets

If there is no keyspace that will yield useful clustering, and if every time two rulesets are merged, their keys will intermingle chaotically, what is the benefit in attempting to organise a ruleset into a tree structure from which common subtrees can be identified?

The benefit is that, despite the chaotic keyspace, there are significant common subtrees to be found if the two rulesets being merged are of significantly different size.

Suppose that there are N rules in the universe of rules. Suppose that we represent a ruleset by an array of N/B buckets, each of which consists of an array of B slots, one for each of B rules. Thus, the leftmost bucket (numbered bucket 0) contains slots for rules numbered 0 . . . B−1. FIG. 21 shows the merging of two small rulesets. An empty cell means that the table is empty there. The cells with X are cells in the first table that contain at least one entry. The cells with Y are cells in the second table that contain at least one entry. The merging of the two sparse tables generates another (less) sparse table containing Xs and Ys except for one overlap, which generates a new cell Z (containing the union of the contents of the X and Y cells that merged to create it). If these tables were represented using a content-addressed data structure, most of the merged table would be stored as references to components of the other tables. Only the new Z cell would require some new storage space (shaded). So in this case, despite the chaotic nature of the keyspace, the fact that the two rulesets were small meant that most of the resultant table was common to one or the other source tables, because the contents of the two tables collided so rarely.

FIG. 22 shows the merging of a sparsely-populated table with a densely-populated table. The merging of the two tables generates a dense table that is almost identical to the dense table except for some changes caused by the sparse table. These changes are shown as Z. So in this case, despite the chaotic nature of the keyspace, most of the resultant table is common to the densely-populated table, because the contents of the two tables collided so rarely.

FIG. 23 shows the merging of two densely-populated tables. In this case, it does not work out space efficiently. The merging of the two dense tables generates a dense table that contains mostly new material (Z) consisting of the merges of each cell. In this case almost the entire output table is new and unique and will consume new storage space. This is a worst-case merge.

These examples (FIGS. 21 to 23) show that even if the table keyspace (patterns) is completely chaotic, merged rulesets representations are still likely to share significant portions with the rulesets from which they were created, simply because of the probable differing sizes of the rulesets being merged.

One very common case in practice will arise where a user wishes to merge a small (e.g. 100 rules) ruleset that the user has created themselves with a large (e.g. 100,000 rules) public wiki ruleset. This case corresponds to FIG. 22 and is very efficient, resulting in new material whose size is proportional to the size of the smaller ruleset.

### Single-Condensation Priority Vectors Will Naturally Yield Clusters

In contrast to the pattern space, which is not likely to yield useful clustering, the nature of rulesets is likely to lead to useful clustering in the boolean vectors or priority vectors that are used to filter rule firings in the single-condensation. This is because the key space of these vectors is the space of rule numbers, not the space of patterns. While a ruleset's patterns are likely to be scattered randomly throughout the pattern space, a ruleset's rule numbers are likely to be clustered together in practice. If rule numbers are allocated sequentially over time, then if a user spends (say) a single day entering a collection of rules, the numbers of the rules are likely to cluster because the rules will have all been created on the same day. So, if two priority vectors for two different rulesets are to be combined, there is a good chance that the rules in each ruleset will be clustered in different areas of the priority vector. This means that it is likely that there will be significantly large duplicated subtrees in the underlying digital search trees that implement these vectors.

The single-condensation solution has the advance of natural clustering in the data structure (priority vectors) that must be space optimised, but the disadvantage that its single-condensation might generate an excessive number of potential rule firings to look up in the priority vector. The multiple condensation solution has the advantage of applying a condensation of only the ruleset-to-be-applied to the block of text to be analysed, but the disadvantage that the data structure to be optimised has a key value of the rule pattern space where natural clustering is unlikely to occur, resulting in relative space inefficiencies.

### An Overview of Content-Addressed Storage

A content-addressed storage system is a storage system that allows pieces of data (e.g. a block of bytes) to be stored and retrieved using a key that is strongly dependent on the entire contents of the data. For example, a simple content-addressed storage system could allow blocks of zero or more bytes of data to be stored and retrieved by a key being the cryptographic hash (e.g. SHA-1) of the block in question. A user who wishes to store a block B would present the block to the content-addressed store. The content-addressed store would store the block and return to the user the hash of the block h=H(B). To retrieve the block, the user presents h to the content-addressed store, and the content-addressed store will provide a copy of B to the user.

Content-addressed storage provides the advantage that it eliminates the duplicate storage of identical pieces of data. If the same piece of data is stored in the store more than once, the store recognises it as identical and does not store an additional copy. Instead, it returns the hash of the existing copy.

In particular, if the nodes of a tree structure are stored in a content-addressed store, the store will eliminate the duplicate storage of all identical subtrees in the tree. If the nodes of several such trees are stored in the same store, the store will eliminate the duplicate storage of all identical subtrees within the set of all the trees. Thus, for example, if the nodes of a tree have been stored in a content-addressed store, the root can be recorded using the hash of the root node when stored in the store. To make a copy of the entire tree, the root node's hash need only be copied.

FIGS. 7 to 12 show how the nodes of a digital search tree that contains duplicated subtrees within itself can be stored in a content-addressed store, and how this storage eliminates the duplicate storage of all duplicated subtrees.

Further information on content-addressable storage can be found in Wikipedia at http://en.wikipedia.org/wiki/Content_addressed_storage

### Overview of Ruleset Inclusion

Ruleset inclusion is the structure that causes the problem that this invention solves, so it is worth reviewing in depth.

In a working system, each ruleset can include other rulesets, and those rulesets can contain other rulesets, so that the rulesets can be connected together in a complicated structure (FIG. 13). The rules in a ruleset are then the union of the transitive closure of the rulesets that it includes (FIG. 14).

In a more complicated system, rulesets can both include and exclude the rules in another ruleset. For example, a ruleset specification for ruleset X might specify that it includes the rules in ruleset Y, but excludes the rules in ruleset Z. So X would end up containing all the rules that are in Y, but not Z. In this aspect of the invention, questions of precedence soon arise. For example, if a ruleset includes rulesets A and B, but excludes C and D, do the exclusions override the inclusions? Adding the rules in A, subtracting the rules in C, adding the rules in B, and then subtracting the rules in D could generate a different ruleset from adding the rules in A and B and then subtracting the rules in C and D.

One way to resolve the precedence issue is to organise a ruleset's inclusions and exclusions as an ordered list of commands to be executed (to be called an “inclusion list”). For example:
+A
−C
+B
−D

This list says to add the rules in A, then exclude the rules in C, then add the rules in B, and then exclude the rules in D.

### Rule Priorities

Ruleset inclusions and exclusions allow rulesets to include (and exclude) other rulesets so that each ruleset defines a subset of the universe of all rules. This subset can be represented as a boolean array indexed by rule number and represents the entire semantics of the ruleset.

However, sometimes more information than a set is required. When a collection of annotations has been prepared, but there are too many, there is a need to rank the annotations and select the best ones. For example, if a user has requested to see just the top five annotations of a text, the annotations must be ranked to find the top five.

Rankings can be calculated if a ruleset assigns a priority value (e.g. in the range [0,9]) to each rule rather than a boolean that simply define whether the rule is included. These priority values can be applied to rulesets to favour some rules over other. For example, suppose that a user has created 20 rules that catch common errors that the user makes. Suppose that the user also wishes to use a general ruleset created by other users that contains 1000 rules. If the user's own ruleset is not given a higher priority, annotations generated by the general ruleset are likely to dominate any report. To solve this problem, the user could assign a priority of one to the general ruleset and two to the user's own ruleset.

To implement rule priorities, the boolean array is replaced with an array of priority values (e.g.) in the range [0,9] called a priority vector. Whereas previously each ruleset defined a subset of rules, under the enriched structure, a ruleset assigns a priority value (e.g. in the range [0,9]) to each rule in the system, with 0 meaning that the rule is not a member of the ruleset and [1,9] meaning that the rule is a member with the specified priority.

Priority values can be incorporated into ruleset lists by attaching a priority to each entry in the list. The priority values replace the − and + indicators shown earlier, with 0 corresponding to − and values in the range [1,9] corresponding to +(and refining it). For example:
5 A
0 C
3 B
0 D

Whereas − and + values define set inclusion and exclusion and are straightforward, numerical priority values raise a number of questions in relation to ruleset lists. Given that each ruleset now defines a priority vector that might contain different priorities for different rules, how is a command such as “3 B” above to be interpreted? Here are some possibilities:
Masking: The members of B that have a non-zero priority are assigned a priority of 3.
Copying: The members of B that have a non-zero priority within B retain that priority (with the 3 being ignored).
Scaling: The members of B that have a non-zero priority are assigned a priority being their existing priority multiplied by 3/9.
Normalised Scaling: The members of B that have a non-zero priority are scaled so that the highest priority in the scaled B is 9. Then these values are multiplied by 3/9.

Ultimately, each ruleset defines a priority vector, which constitutes the ruleset's entire semantics.

As rulesets do not include all rules, sometimes it is advantageous for priority vectors to include empty values in addition to priority values. If a rule's priority in a priority vector is “empty”, it means that the vector does not specify a priority for that rule. When this vector is blended with another vector that does specify a priority for the rule, the second vector's priority for the rule will be used.

### Actions

The present invention is particularly useful with pattern/message rules. However, in an aspect of the invention, pattern/action rules are used instead, where an action could be any action, including, but not limited to:
Replacing the matching text with some text.
Playing a sound.
Sending an email message.
Adding an entry to a log.
Applying a simple transformation to the text such as converting it to upper case.
Linking to the rule's extended information.
Deleting the matching text.

### Protections

In some embodiments, it will be advantageous to implement a protection system for rules and rulesets. Given a universe of users of the system, a user who has created a rule or ruleset might want to restrict access to the rule or ruleset to a subset of the universe of users. For example, a user might want to restrict access to a ruleset created by a company to only those users who are employees of the company.

A user might want to define several groups of users and include groups within other groups. For example, a user might define a group for each division of a company and then define a group for the entire company that includes all of the divisional groups. Some rulesets would be accessible only by a division, but other rulesets would be accessible by the entire company.

Where groups include other groups, it might become somewhat computationally expensive to determine whether a particular user is allowed to access a particular rule or ruleset, and, if this is the case, it can impact the matching data structures.

### Protection Relationships

In some embodiments, it will be advantageous to enforce strict policies for the protection relationships between rulesets.

Consider the case where a ruleset includes other rulesets in a complicated structure. In general, a ruleset might include hundreds of other rulesets and thousands of rules. If a single-condensation solution is being used, then a single priority vector will be created for each ruleset. When a text is analysed, it is processed using the condensation, resulting in a set of matches. The matches' rules will then be looked up in the priority vector to determine which ones should fire. A problem then arises because each rule must then be tested to see if it is allowed to be accessed by the user who presented the text. This can be computationally expensive.

One way of avoiding having to test rules for access permissibility at the point of text analysis is to enforce a policy that each ruleset S is not allowed to include a rule or ruleset that is less accessible than S. By “less accessible” is meant“is not accessible to all users that can access S”. If this policy is strictly enforced at all times, then when a ruleset is invoked by a user to analyse a text, a single test to ensure that the user is allowed to access that ruleset can be used to confirm that the user is allowed to access all of the rules within the ruleset. This simplifies text analysis because it completely eliminates the need to check the protection of rules that have a positive priority in a ruleset's priority vector.

### Compressing Priority Vectors Using Conventional Compression

If priority vectors are sparse, or contain some priority values more than others, a wide range of conventional compression techniques can be used to reduce the amount of space they consume.

A survey of convention compression techniques can be found in the book “Adaptive Data Compression” by Ross N. Williams (Kluwer Academic Press, 1991). In particular, section 1.5.1.1 titled “Binary Run Length Coding” provides an overview of some methods for compressing bit vectors. These techniques could be employed to create compressed representations of ruleset boolean vectors. A simple run-length code can be very effective. For even better compression, some other techniques reviewed in that section could be deployed.

### Compressing Priority Vectors Using Content-Addressed Data Structures

We now turn to compression made possible by identifying similar parts of different priority vectors.

There is no need to keep track of the relationships between rulesets in order to compress the priority vectors. All that is required is to create data structures that identify and compress the common parts in the collection of vectors being stored. This can be done in a number of ways. One way to store the priority vectors space-efficiently is to use a content-addressed data structure.

A content-addressed data structure is one where a unit of data is indexed by its entire content, or by the hash of its entire content. Content-addressed data structures can eliminate the need to store common spans of data more than once. For this reason, they are sometimes also referred to as “single-instance stores.”

An observation (about multiple boolean arrays representing ruleset membership of rulesets with complicated inclusion relationships) is that it is unlikely that two boolean arrays will share a significant common span of boolean values in different parts of the two arrays. This is because different parts of the array correspond to different clusters of rules, and the patterns of invocation of one cluster are unlikely to be duplicated in a completely different group of rules. Any redundancy is likely to be found in corresponding positions in different ruleset vectors. This means that we can employ compression techniques that attend only to position-related redundancy, and not expend effort attempting to find common spans of data at different positions within different arrays.

In an aspect of the invention, each boolean array is stored in the leaves of a digital search tree. FIG. 7 shows a boolean array of length 27 and a corresponding 3-furcation 3-level digital search tree with 27 leaves, each of which stores a boolean.

If, for example, there were 1000 rules (numbered 0 . . . 999), a boolean array could be stored in a digital search tree with a furcation of 10 at each of three levels (which also correspond to the rule number's decimal digits). There would be 1000 leaf nodes corresponding to the rule numbers [0,999]. Each leaf node would store a boolean value. Each non-leaf node would consist of an array of 10 elements, each of which contains the cryptographic hash of the corresponding child node. The cryptographic hash of each node would be calculated by taking the cryptographic hash of the content of the node. For example, the cryptographic hash of a non-leaf node would consist of the hash of the concatenation of the 10 hashes stored in the node. The cryptographic hash of leaf node would consist of the hash of the boolean.

Cryptographic hashes are usually 128 hits or wider. The probability of two pieces of data having the same hash is usually less than 1 in 2¹²⁸.

The data structure could be optimised further by eliminating the leaf nodes and storing the boolean values in the nodes one level above the leaf nodes instead of storing them as the cryptographic hashes of the boolean values in the leaves. FIG. 8 shows the tree of FIG. 7 optimised in this way. The tree could be optimised further by consolidating the next level of nodes into arrays too (so that there would be only three non-root nodes in the tree, and each would hold an array of nine leaf values).

All the nodes in the tree are then stored in a key/value table (e.g. a hash table) whose keys are cryptographic hashes and whose values are non-leaf nodes. Because the table is content-addressed (by cryptographic hash of the node's content), if a tree contains two identical non-leaf nodes, only one copy will be stored. If more than one boolean vector is stored in this data structure, all identical non-leaf nodes will be identified and stored just once. FIGS. 9 to 12 depict the transformation of the storage of the digital search tree from being stored using an ordinary tree structure (e.g. using pointers) to being stored in a content-addressed table that eliminates the duplicate storage of identical nodes.

Reference counting can be used to identify unused nodes in the hash table. These can arise when trees are operated upon.

The data structure described has the advantage of eliminating most of the parts of a collection of boolean vectors that are identical. It has the disadvantage that, when looking up an element in the array, what was previously a simple array lookup is now a three-level tree traversal from the root to a leaf. So long as the tree depth doesn't get too high, this should not be a significant cost, given the compression benefits of this representation. It should be noted that while the content-addressed structures are linked together using hash values, these links can also be stored as references too. This means that when looking up an entry in a compressed boolean vector, one can follow references rather than having to calculate hashes. This is much faster.

### The Single-Condensation Data Structure Hierarchy

In the single-condensation solution, all the rules in the universe of rules are condensed into a single condensation. This condensation can be used to apply all the rules to a block of text in a single pass, generating all matches. FIG. 1 shows a set of rules and FIG. 3 shows a word tree condensation of those rules.

A priority vector is created for each ruleset and the priority vector for the ruleset that was invoked for analysis is used to filter the matches. FIG. 6 shows this, (but with boolean present/absent values rather than priority values).

In the single-condensation solution, the condensation of the universe of rules can be represented in a variety of ways, but is unlikely to contain much redundancy. The real challenge is to find an efficient representation for the priority vectors, which are likely to contain significant redundancy because many of the rulesets corresponding to the priority vectors will be the product of combining other rulesets.

FIG. 27 shows an example data structure hierarchy that can be used to store rulesets' priority vectors in a way that eliminates much of the cross-vector redundancy. A digital search tree is constructed for each priority vector. The priority vectors are all the same length and so it is easy to make the digital search trees the same size too. As shown in FIG. 7, the values in the priority vector are stored only in the leaves of the digital search tree.

Once a digital search tree has been created for each priority vector, the search trees are all stored together in a single content-addressed store. This is achieved by storing each node of each search tree in the content-addressed store as a separate content-addressed piece of data. FIGS. 8 to 10 show the process of storing a single tree in the store starting from the leaves and moving up, finally generating the completely stored tree in FIG. 11.

### The Multiple-Condensation Data Structure Hierarchy

In the multiple-condensation solution, a separate condensation is created for each ruleset. There is no need for priority vectors (though they could be employed in some cases), but the ruleset condensations are likely to be highly space redundant and the challenge is to eliminate this redundancy.

FIG. 26 shows an example data structure hierarchy that can be used to store the ruleset condensations efficiently. First, each ruleset is condensed into a word tree, an example of which is shown in FIG. 3. The word tree structure provides a very efficient condensation for processing blocks of text.

A hash table is then created for each word tree, and each word tree is stored in its own hash table. A separate section in this specification titled, “Storing A Tree In A Hash Table”, describes how this can be done. The keys of the hash table are the strings corresponding to the nodes in the tree, and the values in the hash table are the values in the tree nodes (e.g. messages, or rule identities). There are at least two advantages in storing each tree in a hash table. First, it can make traversing the tree very fast because the words in the block of text being parsed can be progressively hashed (see a separate section in this specification titled “A Note On Hash Calculations”) and looked up in the hash table directly rather than having to search whatever data structure is used to implement the tree furcations. Second, by locating the tree nodes in key-addressed positions in a single linear table, it is likely to be simpler to identify redundancy between hash tables than it is to identify it in the original tree structures, whose nodes are likely to reside in essentially random locations within a memory heap.

At this point, there is a collection of hash tables, one for each ruleset. The hash tables are likely to contain a lot of cross-table redundancies in identical positions in the tables. However, a method of actually compressing them has not yet been deployed.

The next step is to store each hash table in a digital search tree whose key is the hash table index and whose leaf values hold the hash table entries. FIG. 7 shows how a binary vector can be stored in a digital search tree, and the same principle applies for storing a hash table of entries. The purpose of storing each hash table in a digital search tree is to introduce structure that can become a target for redundancy elimination.

Once each hash table has been stored in its own digital search tree, the digital search trees can be stored in a single content-addressed store. To achieve this, each node in each of the digital search trees is stored individually in the content-addressed store. The purpose of storing the digital search trees in the content-addressed store is to eliminate the duplicate storage of identical subtrees within the entire set of digital search trees.

Thus, the word trees create the parsing efficiency. The hash table flattens the tree into a form where identically-keyed nodes can be found in the same place. The digital search tree artificially creates a hierarchical structure within the hash table from which will arise large pieces of identical data. Duplicate copies of these are then eliminated by the content-addressed store.

This hierarchy of data structures has been described as a sequence of steps in transforming a ruleset into a collection of data elements in a content-addressed node store. However, in practice, the entire hierarchy would be operating simultaneously.

### Storing a Tree in a Hash Table

In an aspect of the invention, a word tree (or character tree or similar tree) (whose nodes store messages or references to rules) is stored in a hash table. This can be achieved by storing each node in the tree as an entry in the hash table with each entry's key being the string corresponding to the tree's node, and the entry's value being the message or rule reference.

For example, to store the word tree in FIG. 3 in a hash table, the node representing the string “marshall art” would be stored in the hash table with a key of “marshall art” (this key would be hashed to generate the index in the hash table) and with a value being the message (or a reference to the message) “Did you mean ‘martial art”’.

Once all the nodes in a tree have been individually stored in the hash table, the tree has been stored in the hash table. In this form, the tree provides an advantage and disadvantage over its previous direct tree form. The disadvantage is that, given a node, it is no longer possible to enumerate efficiently the child nodes of a node. The advantage is that it is now possible to start with a string and instantly tell whether it is present in the tree without having to traverse the tree. Yet, given a sequence of words to match (e.g. from a block of text being matched), it is still possible to traverse the tree from root to leaf.

### A Note on Hash Calculations

If a word tree is represented using a hash table, and the furcations of the word tree are not represented within nodes in the table (so that hashing is required to move from level to level in the tree), there will be a need to perform successive hashing on the sequence of words being matched. If the next five words in the block of text being matched are W1, W2, W3, W4, and W5, then the matching process will require the calculation of the hashes H(W1), H(W1+W2), H(H1+H2+H3). H(H1+H2+H3+H4), and H(H1+H2+H3+H4+H5) in succession as matching proceeds (where “+” means concatenation or some other information-preserving operation). When a hash calculation is performed, the hash function has an internal state that is updated after each new data element (e.g. a character) is incorporated into the hash. If this internal state is saved after each hash calculation, then it can be used to speed up the next hash calculation. For example, suppose the calculation of H(W1) generated as hash value and a final internal state of S, then S could be used to reduce the amount of time used to calculate H(W1+W2) because the work required to process W1 has already been done. This optimisation can be used when matching a block of text against a condensation of rules.

### Reference Counting

Whenever there is a data structure that forms a graph structure rather than a tree structure, and which is being operated upon dynamically, there is a danger that some nodes of the graph will become detached and isolated, with no other node pointing to them. Such nodes are known as garbage and use up space unnecessarily. Garbage can be detected and deleted using a class of techniques known as garbage collection. One simple garbage collection technique is to record in a field in each node the number of references that currently exist to the node. This is called a reference count, and when a reference count falls to zero, the node is garbage and can be deleted.

If a static set of rulesets are to be condensed into condensations that share many components through reference, but no changes are to be made to the rulesets, then there is no need for reference counting. However, if the rulesets are to be changed, and their corresponding condensations updated accordingly, reference counting might be required to ensure that garbage does not accumulate and use storage space unnecessarily.

### Multiple-Condensation Solution and Priorities

So far, the multiple-condensation solution has only been described in terms of sets of rules. However, it should be noted that priorities can be introduced simply by storing a priority in each leaf of the word tree.

### Direct References in Content-Addressed Stores

When a data structure is built on top of a content-addressed store so as to eliminate redundancy (see FIGS. 16 to 19), and where the content-addresses store is indexed by a hash of the content, there might be an assumption that hashes are required to traverse the data structure. This is incorrect. A data structure that is stored in a content-addressed store can be augmented with direct references that eliminate the need to use hashes to move around the data structure.

As an example, consider the case of the digital search tree structure shown in FIG. 18 whose nodes are stored in a content-addressed store as shown in FIG. 19. Without additional references, each step in traversing the tree of FIG. 18 would involve looking up a hash in the array in the current node (using a digit index 0,1, or 2), and then using the hash to look up the content-addressed table in FIG. 19 to get to the child node. Depending on how the content-addressed store is organised, this lookup operation could be time consuming. These lookups can be avoided by including a direct reference to each child node in the tree along with each hash. For example, in FIG. 18, the node H11 would contain not just the array of three hashes H8, H9, and H10, but also an array of three direct references (e.g. pointers) to the nodes H8, H9, and H10.

The ability to eliminate the need to perform hash lookups in the content-addressed store could yield significant speed efficiencies. In the single-condensation solution, where it is necessary to perform large numbers of priority vector lookups in order to eliminate matching rules that aren't members of the invoked ruleset, the ability to traverse the digital search tree (that is representing the priority vector) quickly is important. By constructing the tree using direct references as well as content-addressed hash values, the tree can be traversed very quickly (perhaps requiring only a few machine instructions per link) to the leaf that contains the priority value.

### Word Trees and Character Trees

In this specification, word trees have been used extensively. This is because they are very efficient when patterns are word lists, and because they are conceptually simple to explain. However, words are not the only unit that can be used to parse and analyse blocks of text.

One alternative to word trees is character trees. In a character tree, each arc in the tree is labelled with a character rather than an entire word. This leads to a much deeper tree, but one with a far lower furcation.

Another alternative to word trees is N-character trees, where N is a small integer constant (e.g. 3).

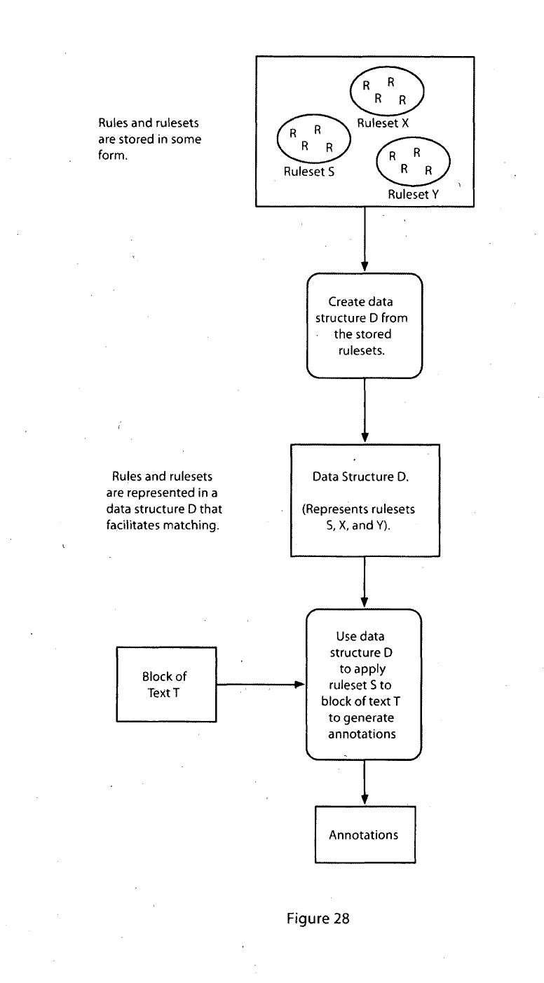

FIG. 28 shows the creation of data structure D from a plurality of stored rulesets (S, X, and Y). These rulesets are represented in a data structure D that represents the rulesets in a way that allows any ruleset to be applied efficiently to a block of text.

Here the particular ruleset S (as represented in D) is applied to the block of text T to generate annotations.

### Specific Embodiments are Illustrative

Specific embodiments of the invention are described in some detail with reference to, and as illustrated in, the accompanying figures. These embodiments are illustrative, and are not meant to be restrictive of the scope of the invention. Suggestions and descriptions of other embodiments may be included within the scope of the invention, but they may not be illustrated in the accompanying figures or alternatively features of the invention may be shown in the figures, but not described in the specification.

### Platforms

Aspects of the invention could be deployed on a variety of different computer platforms. In each case, the user/rule/ruleset data could be stored in a central server, with its possible distribution to remote client computers, or the client/server combination could be replaced by a single computer that holds all the user/rule/ruleset data, and analyses blocks of text directly.

In an aspect of the invention, the function of calculating a set of annotations (possibly sorted by expected utility) of a block of text is distinguished (and possibly performed separately) from the function of presenting the annotations to the user.

In a related aspect of the invention, a computer server (“server”) stores the information about users, rules, and rulesets, and the user, using a client computer (“client”), sends the block of text to be analysed to the server (or provides a reference to the block of text). The server analyses the block of text and generates a collection of annotations. It delivers this collection of annotations to the client, possibly sorting them by some metric first, possibly transmitting only the top N rules by that metric, and possibly delivering only some information about the rules' identifiers so that the client must later fetch more information about the annotations' rules as required by the user. The client could then present the annotations to the user in a variety of forms, with or without further communication with the server. For example, if the server delivered the top 100 annotations, the client could present only the top five annotations, revealing the others only on request from the user and without recourse to the server.

Without limitation, the aspects of the generation of annotation and the display of annotations could be distributed between different computer systems. Here, without limitation, are some of the architectures that could be used.

In an aspect of the invention, the invention is embodied in a computer server that serves a website.

In an aspect of the invention, the invention is embodied in a computer server and a smart phone.

In an aspect of the invention, the invention is embodied in a computer server and a tablet computer.

In an aspect of the invention, the invention is embodied in a computer server and presented using an email interface. Users send a block of text by email to the server and the server emails back the annotations.

In an aspect of the invention, the invention is embodied in a computer server that presents a programmer's network interface, allowing programmers to create interfaces on new platforms.

### No Restriction

It will be appreciated by those skilled in the art that the invention is not restricted in its use to the particular application described. Neither is the present invention restricted in its preferred embodiment with regard to the particular elements and/or features described or depicted herein. It will be appreciated that various modifications can be made without departing from the principles of the invention. Therefore, the invention should be understood to include all such modifications within its scope.

Details concerning computers, computer networking, software programming, telecommunications, and the like may, at times, not be specifically illustrated as such were not considered necessary to obtain a complete understanding nor to limit a person skilled in the art in performing the invention, are considered present nevertheless as such are considered to be within the skills of persons of ordinary skill in the art.

A detailed description of one or more preferred embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications, and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

“Logic,” as used here in, includes but is not limited to hardware, firmware, software, and/or combinations of each to perform a function(s) or an action(s), and/or to cause a function or action from another component. For example, based on a desired application or needs, logic may include a software controlled microprocessor, discrete logic such as an application specific integrated circuit (ASIC), or other programs are logic device. Logic may also be fully embodied as software.

“Software,” as used here in, includes but is not limited to one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skilled in the art that the form of software is dependent on, for example, requirements of a desired application, the environment it runs on, and/or the desires of a designer/programmer or the like.

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. Software modules, also known as computer programs, computer codes, or instructions, may contain a number a number of source code or object code segments or instructions, and may reside in any computer readable medium such as a RAM memory, flash memory, ROM-memory, EPROM memory, registers, hard disk, a removable disk, a CD-ROM, a DVD-ROM or any other form of computer readable medium. In the alternative, the computer readable medium may be integral to the processor. The processor and the computer readable medium may reside in an ASIC or related device. The software codes may be stored in a memory unit and executed by a processor. The memory unit may be implemented within the processor or external to the processor, in which case it can be communicatively coupled to the processor via various means as is known in the art.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

The reference to any background or prior art in this specification is not, and should not be taken as, an acknowledgment or any form of suggestion that such background or prior art forms part of the common general knowledge.

1. A method for generating annotations for a block of text T using a ruleset S, the method comprising the steps of:
(a) storing a plurality of rulesets containing a plurality of rules created by a plurality of entities, each-rule comprising a text pattern and a message;
(b) representing a plurality of rulesets in a data structure D that allows any ruleset R to be applied to a block of text to generate annotations such that the operation has a time complexity less than O(RT); and
(c) using D to apply a particular ruleset S to T to generate annotations.

2. The method of claim 1 wherein the data structure D includes at least one boolean vector; where step (c) of claim 1 includes matching T with at least the rules in S and at least one other rule and using the boolean vector to filter the matches.

3. The method of claim 2 wherein the boolean vectors are represented in a compressed form by compressing them independently.

4. The method of claim 2 wherein the boolean vectors are represented in a compressed form by identifying redundancies within the entire set of boolean vectors.

5. The method of claim 4 wherein each boolean vector is represented using a tree structure, where the nodes of the tree are stored in a content-addressed data structure.

6. The method of claim 2 wherein priority vectors are used instead of boolean vectors.

7. The method of claim 6 wherein the priority vectors are represented in a compressed form by compressing them independently.

8. The method of claim 6 wherein the priority vectors are represented in a compressed form by identifying redundancies within the entire set of priority vectors.

9. The method of claim 8 wherein each priority vector is represented using a tree structure, where the nodes of the tree are stored in a content-addressed data structure that stores all the priority vectors.

10. The method of claim 1, wherein the data structure D consists of a data structure for each ruleset that allows the patterns of the ruleset to be applied to a block of text T wherein step (c) includes using the data structure corresponding to ruleset S to generate annotations.

11. The method of claim 10 wherein each ruleset's data structure is a tree structure whose nodes represent strings and whose arcs are labelled with strings, wherein each ruleset's tree structure can point to subtrees in other rulesets' trees to reduce duplication.

12. The method of claim 10 wherein each ruleset data structure is a hash table containing every pattern in the ruleset, wherein each hash table is stored within a digital search tree whose nodes are stored in a content-addressed store.

13. The method of claim 10 wherein each ruleset data structure is a hash table containing each pattern and its ancestor nodes, wherein each hash table is stored within a digital search tree whose nodes are stored in a content-addressed store.
